(19) United States
(12) Patent Application Publication
(10) Pub. No.: US 2005/0228166 A1
(43) Pub. Date: Oct. 13, 2005

(54) Anomalous expansion materials

(76) Inventors: Cameron John Kepert, New South Wales (AU); Andrew Leslie Goodwin, New South Wales (AU)

Correspondence Address: LADAS & PARRY LLP, 224 SOUTH MICHIGAN AVENUE, SUITE 1600, CHICAGO, IL, 60604, US

(21) Appl. No.: 10/520,249

(22) PCT Filed: Jul. 4, 2003
(86) PCT No.: PCT/AU03/00864

§ 371 Date: May 10, 2005

(30) Foreign Application Priority Data
Jul. 5, 2002 (AU) 2002950015

(51) Int. Cl. C08G 73/00

(52) U.S. Cl. 528/422

(57) ABSTRACT

A method for controlling the thermal expansion behaviour of a material comprises the step of incorporating into the material a component including one or more diatomic bridges. The or each diatomic bridge extends between two atoms in the component. The method is characterised in that the or each diatomic bridge has at least one vibrational mode that causes the two atoms on either side of the bridge to be moved together to a similar or greater extent than competing vibrational mode(s) that cause the two atoms on either side of the bridge to be moved apart. The bridge may also be polyatomic. New materials and devices comprising a plurality of such diatomic and polyatomic bridges are also defined.

### FIELD OF THE INVENTION

The present invention relates to a method for controlling the thermal expansion behaviour of a material. The invention also relates to materials and devices having controllable thermal expansion. The term “anomalous” is used herein to define material expansion which is other than expected, such anomalous expansion including negative, zero or even positive expansion behaviour.

### BACKGROUND TO THE INVENTION

A vast majority of materials expand when heated. This behaviour is typical (as opposed to anomalous) and is often undesirable in many technological fields. For example, in the field of optics, a relatively small increase in the volume of supports for mirrors and other optical devices can cause large changes in critical performance parameters, such as focal lengths or diffraction widths.

A limited number of known tungstate, molybdate and vanadophosphate compounds display negative thermal expansion (NTE) behaviour. Examples are disclosed in U.S. Pat. Nos. 5,322,559; 5,433,778; 5,514,360; 5,919,720; 6,183,716; 6,187,700; 6,209,352; 6,258,743; in WO 00/64827; in EP 995,723; in JP 63-201034 and in JP 02-208256. Other materials known to display some type of NTE behaviour include beta-quartz, beta-eukryptite and silver iodide.

However, various problems have been identified with a number of these materials. For example, the extent of negative expansion is small, limiting their applications. Also, a number need to be synthesised at prohibitively high temperatures. Also, very few if any possess positive physical characteristics such as optical transparency, low density, stability, machinability, crystallinity etc. In addition, many are generally not useable in composites because, to avoid formation of cracks or defects in the composites, it is desirable for the degree of contraction to be equal in all directions (isotropic negative expansion), and for negative expansion behaviour to be exhibited over a large temperature range.

In a publication in the Journal of Solid State Chemistry 134, 164-169 (1997), Williams et al. investigate the disordered crystal structures of Zn(CN)₂ and Ga(CN)₃. They identify negative thermal expansion in Zn(CN)₂ by way of identifying the crystal structure at two separate temperatures but do not demonstrate the continuity of the expansion behaviour, nor identify any general characteristic or understanding of expansion behaviour in that material.

The present inventors, on the other hand, verified negative thermal expansion (NTE) in Zn(CN)₂ and surprisingly discovered that the NTE behaviour was continuous, monotonic and nearly linear over a large temperature range. Having identified this, the inventors surprisingly discovered that the NTE behaviour could be attributed to thermal motion of the CN bridges by correlating the extent of NTE to the behaviour of the thermal parameters of the CN bridge. Having then identified this, the inventors discovered that this thermal motion of the CN bridges could be interpreted in terms of vibrational modes, and in turn, phonon modes.

Two different types of transverse vibrational modes were discovered in M-CN-M′ containing components. The first (referred to hereafter as “δ₁”) involved the displacement of the entire CN bridge away from the M-M′ axis in such a way that both the C and N atoms moved in the same direction. The second (hereafter referred to as “δ₂”) involved, in effect, a rotation of the CN bridge about an axis perpendicular to the central M-M′ axis, causing the C and N atoms to move in opposite directions. The inventors also discovered that these vibrational modes were consistent with the rigid unit theory of phonon modes.

The inventors further discovered that this analysis implied that the transverse vibrational modes of diatomic (and optionally polyatomic) bridges impacted significantly on the distance between two atoms A and B joined by that bridge.

### SUMMARY OF THE INVENTION

Accordingly, in a first aspect, the present invention provides a method for controlling the thermal expansion behaviour of a material comprising the step of incorporating into the material a component including one or more diatomic bridges, the or each bridge extending between two atoms in the component, characterised in that the or each diatomic bridge has at least one vibrational mode that causes the two atoms on either side of the bridge to be moved together to a similar or greater extent than competing vibrational mode(s) that cause the two atoms on either side of the bridge to be moved apart.

When the two atoms on either side of the bridge are moved together to a greater extent than competing vibrational mode(s), the component displays negative thermal expansion (NTE) behaviour; whereas when the two atoms on either side of the bridge are moved together to a similar extent to the competing vibrational mode(s), the component then displays zero thermal expansion (ZTE) behaviour.

The component may comprise a portion or the entirety of the material. Preferably the component comprises a portion of the material in an amount or manner that predetermines the material thermal expansion behaviour. In this way, the proportion of the component in the material can be varied to change the overall thermal expansion behaviour of the material. For example, the proportion of the component in the material can render its thermal expansion behaviour net negative, net zero or of reduced positive thermal expansion, and that expansion behaviour can be isotropic (in all directions) or anisotropic (along one direction).

Preferably the component exhibits δ₁- and/or δ₂-like vibrational modes (as defined above) inducing component negative thermal expansion behaviour. Typically the population of the δ₁- and/or δ₂-like vibrational modes increases when the material is heated, although radiation (eg. infra-red radiation) or another energy source may also have the same effect.

Optionally, anomalous thermal expansion behaviour can occur in some cyanide-containing materials (eg. Zn[Au(CN)₂]₂.x{guest}, where {guest} is as defined below) which arises not only from the δ₁- and/or δ₂-like vibrational effects, but from lattice effects. In this regard, typically such materials include a plurality of diatomic bridges throughout an infinite molecular coordination network defining a lattice structure, whereby changes in lattice geometry can induce eg. material negative thermal expansion behaviour. Typically heating of these materials causes the geometry of the lattice itself to change, often resulting in uniaxial or anisotropic NTE. In addition to these effects, other causes of NTE can include phase transitions, magnetic and electronic transitions and other (not necessarily CN-based) rigid unit modes (RUMs) or phonon modes.

Preferably the diatomic bridge is linear. Negative thermal expansion is typically optimised when the diatomic bridge is linear. In this regard, it is most preferred that the diatomic bridge is a linear cyanide —(CN)— bridge, however, non-linear cyanide or other diatomic bridges may be employed. Other diatomic bridges which may be employed in the method include a carbon monoxide —(CO)— bridge, a di-nitrogen —(NN)— bridge, a nitrogen monoxide —(NO)— bridge, and possibly even a carbide —(CC)— bridge etc.

As defined above, the diatomic bridge extends between two atoms. Preferably these atoms are metals or semi-metals but they may also be non-metals, and combinations thereof. Preferably the component comprises a plurality of diatomic bridges. Optionally for at least some of the diatomic bridges, the two atoms on either side of the bridge can be different atoms, being different metals, semi-metals and non-metals, and combinations thereof.

In addition, the thermal expansion of the material can be tuned by varying the relative ratios between two or more different atoms on either side of the diatomic bridge. In this regard, during material formation, different atoms (eg. a different metal ion) can be “doped” into the material to tune (eg. fine-tune) expansion behaviour.

When a cyanide ion is coordinated to a metal or semi-metal atom, it is preferable that the metal atom coordinates one or more other cyanide ions, which in turn bridge to other atoms.

However, each atom may also coordinate other ligands. These ligands may be uni- or multi-dentate, including but not limited to water, alcohols, diols, thiols, oxalate, nitrate, nitrite, sulfate, phosphate, oxide, sulfide, thiocyanate, non-bridging cyanide, cyanate, nitrogen monoxide, carbon monoxide, dinitrogen etc. Thus, the component can form part of or be defined in a salt. This salt may also be desolvated (usually by heating the salt to drive off the solvent). In this regard, in desolvated salts, it is also not necessary for all coordination sites of the metal atom to be satisfied by a coordinating ligand.

Where the atoms coordinate with other ligands, the component may form part of an assembly that is neutrally, positively or negatively charged. The assembly can, for example, comprise a rigid connected part of the material. When the assembly carries a charge, counter-ions may be incorporated within cavities or pores within the assembly to provide neutrally charged materials. These counter-ions may themselves influence the thermal behaviour of the material, and may also act to influence the expansion behaviour of the material as a whole (eg. by counteracting negative thermal expansion).

The inclusion of counter-ions into the assembly or pores thereof can also confer on the material the ability to exhibit a tuned expansion where eg. the ability to tune the expansion properties arises from ion exchange. In this regard, such tuned expansion can be performed in-situ or by varying preparative conditions. Preferably the counter-ions are varied either by ion exchange or synthetic modification, to vary the thermal behaviour of the material.

The assembly may also include guest molecules (herein sometimes referred to as “{guest}”) in interstitial cavities within a lattice thereof. A number of different types of guest molecules may be incorporated into the assembly. The guest molecules may also confer on the material the ability to exhibit tuned expansion, where the ability to tune the expansion properties in this case arises from solvent exchange and/or solvent sorption and desorption. Again, such tuned expansion can be performed in-situ or by varying preparative conditions. In this regard preferably the guest molecules influence the thermal behaviour and optionally counteract negative thermal expansion behaviour of the material. When the material is porous the guest molecules can be located in pores of the material. Preferably the guest molecules are varied either by sorption/desorption or synthetic modification, to vary the thermal behaviour of the material. Preferably the guest molecules comprise one of more of water, alcohols, organic solvents or gas molecules.

The inventors have observed that the number of possible topologies of such materials is essentially limitless. The inventors have further observed that the topology of a particular material can be determined to some extent by the number of diatomic bridges (eg. cyanide ions) coordinated to each metal centre, and the geometry of this coordination. For example, the topology may be based on a diamond-, wurzite-, quartz-, cubic-, (4,4)-, (6,3)-, (10,3)-, PtS-, NbO-, Ge₃N₄-, ThSiO₂- or PtOₓ-type net. The material may comprise more than one interpenetrating net, and these nets may or may not be of the same topology.

The number, topology and size of interpenetrating nets may also affect the solvent or ion accessible volume of the material. The material may also contain zero-dimensional bridged moieties, such as CN bridged molecular squares.

In a second aspect, the present invention provides a method for controlling the thermal expansion behaviour of a material comprising the step of incorporating into the material a component including one or more multi-atomic bridges, the or each bridge extending between two atoms in the material, characterised in that the or each multi-atomic bridge has at least one vibrational mode that causes the two atoms on either side of the bridge to be moved together to a similar or greater extent than competing vibrational mode(s) that cause the two atoms on either side of the bridge to be moved apart.

In the second aspect both di- and poly-atomic bridges can be employed, for example the di-atomic bridges as defined for the first aspect of the invention, and polyatomic bridges such as cyanamide, dicyanamide, tricyanomethanide, thiocyanate, selenocyanate, cyanate, isothiocyanate, isoselenocyanate, isocyanate, azide, cyanogen and butadyinide. Otherwise, the second aspect is as defined for the first aspect of the invention.

In a third aspect the present invention provides a method for controlling the thermal expansion behaviour of a material comprising the step of incorporating into the material a component that has a coefficient of thermal expansion less than −9×10⁻⁶ K⁻¹.

Preferably the component has a coefficient of thermal expansion that ranges from:
−9×10⁻⁶ K⁻¹ to −21×10⁻⁶ K⁻¹ in all directions (isotropic expansion materials); or
−15×10⁻⁶ K⁻¹ to −62×10⁻⁶ K⁻¹ along any one direction (anisotropic expansion materials).

Only components according to the present invention have been able to achieve such a considerable extent of negative thermal expansion. Otherwise, the third aspect is as defined for the first and second aspects of the invention.

In a fourth aspect, the present invention provides a composite including materials as defined by previous aspects of the invention. The composite may include two or more different such materials, or one or more such materials together with a material that does not include a multi-atomic bridge as defined above (hereafter “unrelated material”). In this regard, the composite may further include a binding agent to bind together the different materials, or the material and unrelated material.

The composite may be tuned (eg. by incorporating therein in a predetermined amount or manner a negative or zero thermal expansion component) with the result that the composite, as a whole, displays negative, zero or positive expansion behaviour.

In a fifth aspect, the present invention provides a method for altering the thermal expansion behaviour of a material that comprises a component having a plurality of diatomic bridges, each bridge extending between two atoms in the component and having at least one vibrational mode that causes the two atoms on either side of the bridge to be moved together to a similar or greater extent than competing vibrational mode(s) that cause the two atoms on either side of the bridge to be moved apart, the method comprising the step of incorporating into the component two or more different atoms such that, for at least some of the diatomic bridges, the two atoms on either side of the bridge are different.

Preferably the thermal expansion is tunable by varying the relative ratios between the two or more different atoms on either side of the diatomic bridge. Preferably the two atoms on either side of the bridge are different metals, semi-metals or non-metals, or combinations thereof.

In a sixth aspect, the present invention provides a material that comprises a component having a plurality of diatomic bridges, each bridge extending between two atoms in the component and having at least one vibrational mode that causes the two atoms on either side of the bridge to be moved together to a similar or greater extent than competing vibrational mode(s) that cause the two atoms on either side of the bridge to be moved apart, wherein, for at least some of the diatomic bridges, the two atoms on either side of the bridge are different.

Preferably the component comprises two or more different atoms and preferably the relative ratios between the two or more different atoms on either side of the diatomic bridge can be varied. Preferably the two atoms on either side of the bridge are different metals, semi-metals or non-metals, or combinations thereof.

In a seventh aspect, the present invention provides a device formed from or comprising a material having controllable thermal expansion behaviour, the material being as defined above for use in the first, second, third and fourth aspects.

In this regard, the device can be:
an optical fibre; a laser; an optical, electronics or thermal electronics component; a substrate or support for an optical component, electronics device or thermal electronics device; a thermal transfer device; a zero insertion force socket; a component for a superconductor, high precision instrument or frequency resonator; an optical device displaying birefringence or that is optically transparent; an interference device; or the device can display: piezoelectric properties; optical activity; or nonlinear optical properties.

Advantageously all of these devices can thus be provided with controllable thermal expansion behaviour, making the devices more reliable and dimensionally stable in use over broader temperature ranges/fluctuations.

In a further unique aspect the present invention provides a method for directing the thermal expansion behaviour of a material, and a material produced by this method. The method comprises the step of incorporating into the material a component including one or more diatomic bridges, the or each bridge extending between two atoms in the component, with the or each diatomic bridge having at least one vibrational mode that causes the two atoms on either side of the bridge to be moved together to a similar or greater extent than competing vibrational mode(s) that cause the two atoms on either side of the bridge to be moved apart, characterised in that the component comprises an anisotropic single crystal that, by virtue of its alignment in the material, directs thermal expansion (ie. anisotropically).

Preferably the component comprises a portion or the entirety of the material.

This unique aspect of the invention can incorporate some of the preferred features of the first, second, third and fourth aspects of the invention as appropriate.

### BRIEF DESCRIPTION OF THE DRAWINGS

Notwithstanding any other forms which may fall within the scope of the present invention, preferred forms of the invention will now be described, by way of example and with reference to the accompanying drawings in which:

FIG. 1 shows a schematic representation of a basic structural unit of the ZnₓCd₁₋ₓ(CN)₂ family;

FIG. 2 shows a schematic representation of two interpenetrating diamond-type networks present in the ZnₓCd₁₋ₓ(CN)₂ structural family;

FIGS. 3(a) to 3(d) show four graphs of temperature versus relative change in unit cell volume for four respective members of the ZnₓCd₁₋ₓ(CN)₂ family (in (a) x=1, in (b) x=0.80, in (c) x=0.64 and in (d) x=0);

FIG. 4 shows a representation of the basic structural unit present in Zn^{II}[M^{I}(CN)₂]₂.x{guest} (where M=Ag; Au and {guest} is as defined below);

FIG. 5(a) shows a representation of one of the six interpenetrating beta quartz-type networks present in the structure of Zn^{II}[M^{I}(CN)₂]₂ (where M=Ag; Au);

FIGS. 5(b) and (c) show representations of the six interpenetrating beta quartz-type networks present in the structures of Zn^{II}[Ag^{I}(CN)₂]₂.0.575{Ag^{I}CN} (which contains 1-dimensional chains of Ag^{I}CN within channels running through the networks) and Zn^{II}[Au^{I}(CN)₂]₂ (which contains empty channels);

FIGS. 6(a) and (b) show two graphs of the thermal expansion behaviour of two respective members of the Zn^{II}[M^{I}(CN)₂]₂.x{guest} family (where M=Ag; Au and {guest} is as defined below);

FIG. 7 shows a representation of the basic structural unit in the KCd^{II}[M^{I}(CN)₂]₃ family (where M=Ag; Au);

FIG. 8 shows a representation of one of the distorted cubic nets present in the structure of the KCd^{II}[M^{I}(CN)₂]₃ family;

FIGS. 9(a) and 9(b) show two graphs of the thermal expansion of two respective members of the KCd^{II}[M^{I}(CN)₂]₃ family (where M=Ag; Au);

FIG. 10 shows a representation of the basic structural element of [NMe₄] [Cu^{I}Zn^{II}(CN)₄];

FIG. 11 shows a representation of the diamond-type network present in [NMe₄][Cu^{I}Zn^{II}(CN)₄];

FIG. 12 shows a representation of the tetramethylammonium-filled adamantanoid cavities present in the structure of [NMe₄][Cu^{I}Zn^{II}(CN)₄];

FIG. 13 shows a graph of the thermal expansion behaviour of [NMe₄][Cu^{I}Zn^{II}(CN)₄];

FIG. 14 shows a representation of one of the ‘square grids’ (so-called(4,4)-nets) present in the structure of Cd^{II}Ni^{II}(CN)₄.xH₂O;

FIG. 15 shows a representation of the structure of Cd^{II}Ni^{II}(CN)₄.xH₂O, showing the stacking of cyanide-bridged square grids with alternating cadmium and nickel centres;

FIG. 16 shows a representation of the basic structural unit present in Cd^{II}Pt^{II}(CN)₄;

FIG. 17 shows a representation of the crystal structure of Cd^{II}Pt^{II}(CN)₄.xH₂O;

FIGS. 18(a) and 18(b) show two graphs of the thermal expansion behaviour of two respective members of the Cd^{II}M^{II}(CN)₄.xH₂O family (where M=Ni; Pt);

FIG. 19 shows representations of the two transverse vibrational modes present in Zn(CN)₂ (and similar systems with linear M-CN-M′ linkages);

FIGS. 20(a) and (b) show rigid unit modes (RUMs) present in Zn(CN)₂ (given for zero (a) and arbitrary (b) wave-vector), where the zinc coordination spheres are depicted as the tetrahedra, and the cyanide linkages as the joining rods between the tetrahedra;

FIG. 21 shows the variation of thermal displacement parameters of atoms in Zn(CN)₂ as determined by single crystal X-ray diffraction;

FIG. 22 shows a schematic representation of the single cubic (α-Po) network present in the Ga(CN)₃ structural family;

FIGS. 23(a) and (b) shows graphs of the thermal expansion behaviour of M^{II}Pt^{IV}(CN)₆.2{H₂O) (in (a) M=Cd; in (b) M=Zn), the top curve showing data collected on heating and the bottom curve showing data collected on cooling after the water molecules had been removed from the structure to give M^{II}Pt^{IV}(CN)₆ (M=Cd; Zn);

FIGS. 24(a) and (b) show rigid unit modes (RUMs) present in M^{II}Pt^{IV}(CN)₆ (given for zero and arbitrary wave-vector, respectively), where the M^{II} and Pt^{IV} coordination spheres are depicted as the octahedra, and the cyanide linkages as the joining rods between the octahedra; and

FIGS. 25(a) and (b) show the variation of thermal displacement parameters of atoms in M^{II}Pt^{IV}(CN)₆ (in (a) M=Cd; in (b) M=Zn), as determined by single crystal X-ray diffraction.

### MODES FOR CARRYING OUT THE INVENTION

Prior to describing the present invention in detail, further background on how the present inventors arrived at the present invention is provided.

The inventors first observed that in the above described prior art materials, negative thermal expansion (NTE) arose from vibrations of a single O-atom bridge. In this regard, both ZrW₂O₈ and Sc₂W₃O₁₂ (disclosed in the above referenced patents) were noted to be examples of oxide-bridged NTE compounds, in which NTE properties arose from thermally induced vibrations of the oxide bridge.

In these compounds, two atoms (M and M′, for example) are connected by an O atom. As the material is heated, this M-O-M′ link vibrates such that the O atom moves perpendicularly to the M-M′ axis, causing a contraction in the material.

However, from crystallographic studies, the present inventors surprisingly discovered negative expansion behaviour in certain two-atom (or diatomic) bridges and surmised that this negative expansion might also occur in some multi-atomic (ie. greater than two atom) bridges.

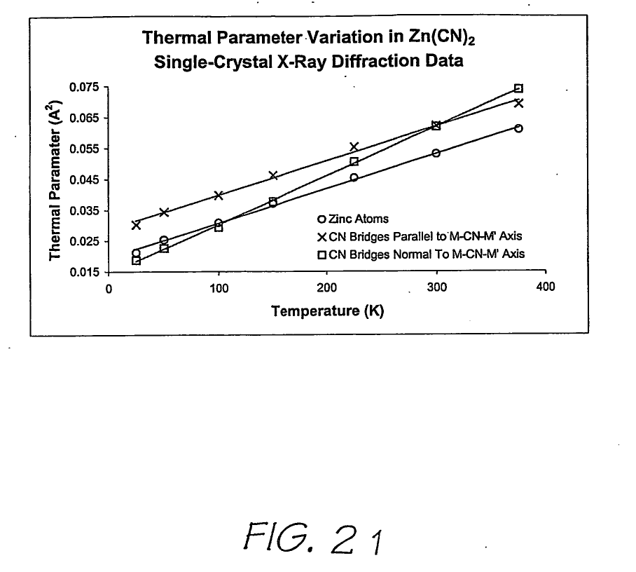

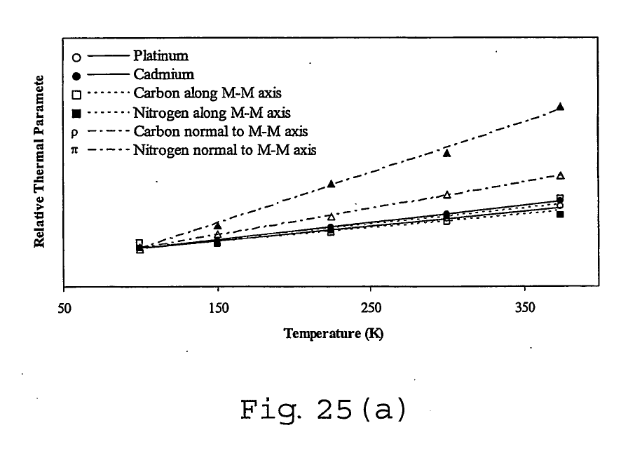

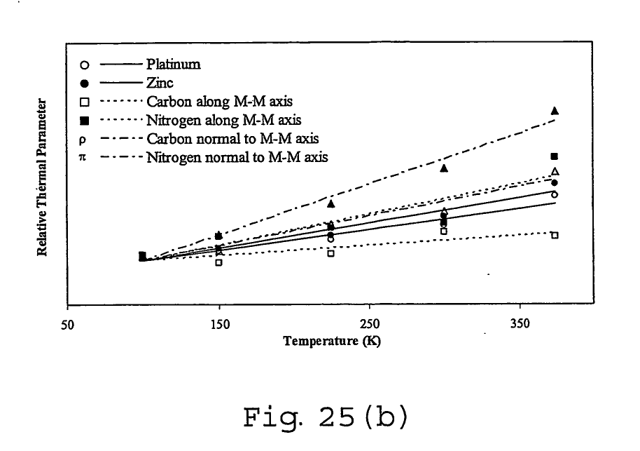

More particularly, the inventors observed that the thermal parameters with cyanide diatomic bridges were increasing with temperature much more quickly than those of the metal atoms to which they were joined. In this regard, reference is made to FIGS. 21, 25(a) and 25(b) which depict the variation of the thermal displacement parameters of atoms in Zn(CN)₂, Cd^{II}Pt^{IV}(CN)₆ and Zn^{II}Pt^{IV}(CN)₆, respectively, as determined by single crystal X-ray diffraction. The thermal parameters of the CN bridge normal to the M-CN-M′ axis can be easily seen to increase significantly more rapidly with increasing temperature than other thermal parameters.

This analysis enabled the inventors to characterise the mechanism of negative expansion in the cyanide —(CN)— bridge. In particular, they surprisingly discovered the effects of vibrational modes of the diatomic bridge. These included the δ₁ and δ₂ vibrational modes (defined above) which, when thermally populated, contributed to negative expansion in materials incorporating these bridges. They also discovered materials in which lattice effects as well as NTE vibrational modes contributed to the anomalous thermal expansion behaviour, leading to the discovery and characterisation of a whole host of new materials with varying expansion properties.

They further discovered that, depending on the proportion, distribution and type of diatomic bridges in a given material, anomalous expansion behaviour resulted, namely negative thermal expansion (NTE), zero thermal expansion (ZTE) or positive thermal expansion (PTE). By controlling the proportion, distribution, type of diatomic bridge and the atoms being bridged, the inventors obtained tunable thermal expansion (TTE).

Preferred materials according to the present invention were then able to be formulated to include one or more A-CN-B components (where A and B were the same or different atom, preferably a metal or semi-metal, but also a non-metal, and combinations thereof). Other diatomic bridges included carbon monoxide A-CO-B, di-nitrogen A-NN-B, nitrogen monoxide A-NO-B, and carbide A-CC-B.

The thermal expansion behaviour of materials was quantified by the coefficient of thermal expansion α1, defined as the relative change in length per unit temperature change. Typically observed expansion values of α1 for common materials were noted to be of the order of 1 to 50×10⁻⁶ K⁻¹.

Prior to the present invention, the most pronounced isotropic NTE behaviour over a significant temperature range was reported for ZrW₂O₈, a compound whose coefficient of thermal expansion was around −9×10⁻⁶ K⁻¹. Of the crystalline/polycrystalline materials that display anisotropic NTE, AlPO₄-17 displayed the most pronounced NTE effect in one direction over a significant temperature range, with a coefficient of thermal expansion of −15×10⁻⁶ K⁻¹.

### Preferred Embodiments of the Present Invention

Methods for controlling the thermal expansion behaviour of solid materials were investigated with a range of solid materials. The methods were observed to significantly enhance the anomalous expansion behaviour of these solid materials over prior art expansion materials (especially in the degree of negative expansion). Initial experiments focussed on cyanide ion bridges.

Cyanide-bridged negative expansion components were observed to have a number of advantages over current NTE materials including:
The extent of negative expansion was observed to be much larger than ever before observed. For example, Cd(CN), exhibited isotropic NTE with a coefficient of thermal expansion of −21×10⁻⁶ K⁻¹ and Zn[Au(CN)₂]₂ exhibited anisotropic NTE with a coefficient of thermal expansion in one direction of −62×10⁻⁶ K⁻¹;
The synthesis of materials including a cyanide-bridged component was considerably simpler than the prior art NTE materials.

Many of the materials according to the invention were able to be synthesised using conventional solvents (such as water), at room temperature, and without specialist equipment, and the starting materials were often low cost and readily available;
In many cases, the thermal expansion properties of the materials were able to be tuned by selective doping of metal sites, modification of guest molecules, modification of counter-ions, and degree of interpenetration of material topology;
For example, the materials were able to be doped in such a way to make them display zero thermal expansion (ZTE);
Also, the materials were able to be doped in such a way to give them useful accompanying properties, such as optical properties by doping with elements such as erbium for use in optical fibres, or in lasers, where controlled expansion properties are highly desirable;
The materials were also able to be applied as substrates and/or supports for optical components such as Bragg diffraction grating, lenses, mirrors, lasers and interference devices; as the construction material for optical components such as Bragg diffraction grating, lenses, mirrors, lasers and interference devices; as substrates, supports and/or components of electronic devices; as bobbins for superconducting coils; in thermal transfer devices and in zero insertion-force sockets;
Many of the materials were able to be grown as large single crystals and to be optically transparent;
Some of the materials displayed piezoelectric (voltage-dependent expansion) properties, which in combination with anomalous thermal expansion rendered the materials useful in interference devices, high precision instruments and frequency resonators;
Some of the materials displayed optical activity, which in combination with anomalous thermal expansion rendered the materials useful in optical devices;
Some of the materials displayed nonlinear optical (NLO) properties, which in combination with anomalous thermal expansion rendered the materials useful in optical devices;
Some of the materials displayed optical birefringence, which in combination with anomalous thermal expansion rendered the materials useful in optical devices;
Some of the materials also enabled the formation of single crystal products containing coefficient of thermal expansion gradients within each crystal, rendering the materials useful in thermal electronics etc;
The negative expansion substances and materials were also able to be incorporated into or formulated as part of other materials to alter the expansion behaviour of those other materials, ie. rendering them net negative, zero or positive expansion materials.

Thus, compounds and methods of the present invention were able to provide materials having predetermined NTE, ZTE, PTE and TTE behaviour.

TTE was applied to materials requiring PTE compensation, and to produce materials displaying particular thermal expansion behaviours. This was achieved both by making materials with specific expansion properties and by making composites of these materials. Compensation for PTE was noted to be of particular importance in the communications industry, for example, where changes in the size of optical diffraction gratings were observed to limit data quality and quantity. Further, TTE was noted to be of particular importance in providing compensation for thermal stress such as occurs in electronic componentry, for example, where thermal cycling leads to a weakening of connections.

These far-reaching improvements rendered the materials produced according to the invention of significant potential application wherever controlled expansion materials were required.

Various materials developed by the inventors including cyanide diatomic bridges will now be described, including their synthesis and characterisation. The following materials were observed to be constituted typically, though not always, by “infinite” molecular coordination networks (for example, where the diatomic bridge is present throughout the material). Further, composites including two or more of these materials (or one of these materials and an unrelated material) were produced.

### MATERIAL EXAMPLES

(a) Materials based on the Zn(CN)₂-type or 2×(6,4) cubic structure (doubly interpenetrating diamond-type nets). Variations included substitution of-divalent metals for some or all of the Zn atoms. Such divalent metal ions included Cd(II), Hg(II), Mn(II), Be(II), Mg(II), Pb(II) and Co(II). Variations also included substitution of mixtures of univalent, divalent and trivalent metal ions for Zn to give materials of the form:
{(M1₂^{II})ₓ₂(M1₂^{II})ₓ₂ . . . (M1ₙ^{II})ₓₙ}{(M2₂^{I}) (M3₁^{III)}y}1{(M2₂^{I})(M3₂^{III})}_{y2} . . . {(M2ₘ^{I})(M3ₘ^{III})}_{ym}(CN)₂ where M1₁ included Zn(II), Cd(II), Hg(II), Mn(II), Be (II), Mg(I), Pb (II) and Co (II); M2, included Li(I) and Cu(I); M3ₖ included Al(III), Ga(III), and In(III); n and m being any non-negative whole numbers with at least one greater than or equal to unity; and (x1+x2+ . . . +xn)+2×(y1+y2+ . . . +ym)=1; and i, j, and k being any positive integer. Examples of this class included Zn(CN)₂, Zn_{0.8}Cd_{0.2}(CN)₂, Zn_{0.64}Cd_{0.36}(CN)₂, Cd(CN)₂, Mn(CM)₂, Zn_{0.5}Hg_{0.5}(CN)₂, Li_{0.5}Ga_{0.5}(CN)₂ and Cu_{0.5}Al_{0.5}, (CN)₂,

(b) Materials of the general formula given in (a) above but with a single diamond-type network rather than two interpenetrating networks, optionally with counterions or molecules incorporated into the structure. Incorporation of counterions into the interstitial cavities required an appropriate inclusion of lower- or higher-valent metals into the network lattice. Examples of this class included Cd(CN)₂.½CCl₂, [Nme₄]_{0.5}[Cu^{I}_{0.5}Zn^{II}_{0.5}(CN)₂], Cd(CN)₂.CMe₄, Cd(CN)₂.CMe₃Cl, Cd(CN)₂.CMe₂Cl₂, Cd(CN)₂.CMeCl₃, Cd(CN)₂.CCl₄, Cd_{0.5}Hg_{0.5}(CN)₂.CCl₄, Cd_{0.5}Zn_{0.5}(CN)₂.CCl₄.

(c) Materials of the general formula given in (a) and (b) above but with more than two interpenetrating diamond-type networks.

(d) Materials based on the Ga (CN)₃-type cubic structure. Some such materials satisfied the general formula {(M1₁^{III})ₓ₁(M1₂^{III})ₓ₂ . . . (M1ₙ^{III})ₓₙ}{(M2₁^{II}) (M3₁^{IV})}_{y1}{(M2₂^{II}) (M3₂^{IV})}_{y2} . . . {(M2ₘ^{II}) (M3ₘ^{IV})}_{yn}(CN)₃ where M1 included trivalent metal ions such as Fe(III), Co(III), Cr(III), Ti(III), Al(III), Ir(III), Ga(III), In(III) and Sc(III); M2 included divalent metal ions such as Mg(II), Zn(II), Cd(II), Co(II), Fe(II), Ru(II), Mn(II) and Ni(II); M3 included tetravalent metal ions such as Pd(IV) and Pt(IV); n and m being non-negative whole numbers with at least one greater than or equal to unity; and (x1+x2+ . . . +xn)+2×(y1+y2+ . . . +ym)=1. Examples of this class included Ga^{III}(CN)₃, Co^{III}(CN)³, Al^{III}(CN)₃, Cd^{II}_{0.5}Pt^{IV}_{0.5}(CN)₃ and Zn^{II}_{0.5}Pt^{IV}_{0.5}(CN)₃.

(e) Materials of the general formula given in (d) above but with other ions or molecules being incorporated into the structure. Incorporation of ions into the interstitial cavities required an appropriate inclusion of lower- or higher-valent metals into the network lattice. Examples of this class included the known Prussian blues compounds (e.g., K[Fe^{II}Fe^{III}(CN)₆]) and their analogues (e.g., Cs₂[Li^{I}Fe^{III}(CN)₆], Cd^{II}_{0.5}Pt^{IV}_{0.5}(CN)₃.H₂O, Zn^{II}_{0.5}Pt^{IV}_{0.5}(CN)₃.H₂O, K[Fe^{II}Fe^{III}(CN)₆].xH₂O).

(f) Materials of the types described in (d) to (e) above but with more than one interpenetrating cubic framework.

(g) Other simple metal cyanides not explicitly belonging to classes (a) to (f) above of the general form (M1ⁿ¹⁺)ₓ₁(M2ⁿ²⁺)ₓ₂ . . . (Mk^{nk+})ₓₖ(CN)ᵢ(.{guest}) where M1, M2 . . . Mk were metals with oxidation states n1+, n2+ . . . nk+ respectively; k and i were positive whole numbers; (x1×n1)+(x2×n2)+ . . . +(xk×nk)=i; and (guest), when present, included any solvent or molecular species such as water, alcohols, organic solvents or gas molecules. Such materials optionally comprised single or multiple interpenetrating regular nets, such as the quartz, NbO, PtS, Ge₃N₄, (10,3), ThSiO₂, PtOₓ or wurtzite nets. Examples included Ag^{I}CN, Au^{I}CN, Zn^{II}Ag^{I}₂(CN)₄ and Zn^{II}Au^{I}₂(CN)₄.

(h) Materials of the general formula given in (g) above but with other ions or molecules incorporated into the structure. Incorporation of ions into the interstitial cavities required an appropriate inclusion of lower- or higher-valent metals into the network lattice. Examples included KCd^{II}[Ag^{I}(CN)₂]₃ and KCd^{II}[Au^{I}(CN)₂].

(i) Materials of the general formula given in (g) above but which contain more than one type of network lattice. Examples included Zn^{II}Ag^{I}₂(CN)₄.0.575Ag^{I}CN.

(j) Materials of the types described in (a) to (i) above but with metal and/or cyanide vacancies within the structure. Such materials were optionally related to materials belonging to classes (a) to (h) by inclusion of metal and/or cyanide vacancies. Examples of this class included Mn^{II}Co^{III}_{0.33}Cr^{III}_{0.33} (CN)₄, Cd^{II}Fe^{III}_{0.33}Co^{III}_{0.33} (CN)₄, Cd^{II}Co^{II}_{0.33}IR^{II}_{0.33}(CN)₄, Pd^{II}Cr^{II}_{0.33}Ir^{II}_{0.33} (CN)₄ and Cu_{II}Co^{III}_{0.66}(CN)₄.

(k) Other materials not explicitly belonging to classes (a) to (j) above that contained cyanide-bridged atoms. Included were cyanide-bridged materials in which the coordination spheres of some or all metal atoms included one or more non-cyanide bridges, such as water, alcohols, diols, thiols, oxalate, nitrate, nitrite, sulfate, phosphate, oxide, sulfide, thiocyanate, (non-bridging) cyanide, cyanate, nitrogen monoxide, carbon monoxide or dinitrogen. Such materials optionally consisted of regular nets, and optionally included interstitial ions or guest molecules. Examples included Ni^{II}(CN)₂.xH₂O, Fe₄[Re₄Se₈(CN)₆]₃.36H₂O, Cd^{II}Ni^{II}(CN)₄.xH₂O and Cd^{II}Pt^{II}(CN)₄.xH₂O.

(l) Materials of the type described in (k) above that contained finite cyanide-bridged species. Such materials optionally contained cyanide-bridged polyhedra, polygons or finite chains. The cyanide-containing species optionally contained branches. Such materials also optionally contained components unrelated or unconnected to the cyanide-bridged moieties.

(m) Materials of the type described in (a) to (l) above where chemical composition varied within the one crystal/crystallite, as was achieved by variation of crystallisation conditions such as concentrations and temperatures during crystallisation. Examples included ZnₓCd₁₋ₓ(CN)₂.

(n) Materials of the type described in (a) to (l) above where structure type, guest inclusion or ion inclusion varied within the one crystal/crystallite, as was achieved by variation of crystallisation conditions such as concentrations and temperatures during crystallisation.

(o) Amorphous materials or glasses based on any of the systems defined in (a) to (n) above.

Preparations of these materials required a source of cyanide ions. Such sources included simple cyanide salts or their solutions, polycyanometallate salts or their solutions, cyanide precursors such as trimethylsilyl cyanide, organic nitrites, isocyanide salts or their solutions, organic isonitriles, hydrogen cyanide gas or its solutions, cyanohydrins or their solutions or any other cyanide-containing solid-, liquid-, gaseous- or solution-phase reagents. Materials were then prepared by a number of methods, including:
(a) Slow diffusion of solutions containing the appropriate metal ions, any other coordinated ligands and a source of cyanide ions;
(b) Diffusion of reagents through thin films, gels or capillaries;
(c) Hydrothermal, solvothermal, and other high-temperature preparations;
(d) Solid-phase reactions, which optionally employed high temperatures and high pressures;
(e) Direct combination of reagents and isolation of products by techniques including precipitation and filtration, evaporation, crystallisation, sublimation and vapour deposition;
(f) Passage of hydrogen cyanide gas (or other gaseous cyanide-precursor) through solutions containing appropriate metal ions, ligands and guest molecules;
(g) Decomposition or reaction of one or more precursor compounds, in which volatile or reactive components of the precursor or precursors were removed or reacted;
(h) Vapour deposition of thin films by techniques including but not limited to chemical vapour deposition, physical vapour deposition, metal organic chemical vapour deposition and plasma assisted chemical vapour deposition;
(i) Vapour deposition of thin films of one or more precursor compounds followed by decomposition or reaction, in which volatile or reactive components of the precursor or precursors were removed or reacted.

Preferred materials according to the present invention had a number of features that made them suitable for physical application, including their facile synthesis, ready availability and unprecedented NTE and TTE behaviours. Further physical applications of materials containing cyanide-bridged atoms included:
(a) Substrates designed to exhibit a specific expansion behaviour; for example, to exhibit ZTE, to match that of another component, such as silicon, or to provide a bridge between two surfaces with differing expansion properties to lessen the stress at the interface between those surfaces. Such materials find use: in electronics as circuit boards or silicon supports; as optical components or supports; as housing or substrates for optical components such as Bragg diffraction gratings; and as supports to accurately align high precision static componentry such as optical fibres, lasers, mirrors and lenses, and high precision dynamic componentry such as cogs, gears and pendula;
(b) Components in composite materials where the expansion properties of the cyanide-containing component are used to compensate for the expansion property of the remaining component. As for (a) above, such compensation may be needed to provide a composite material with a specific expansion behaviour. The applications of these composites were similar to those listed in (a) above, and include also the generation of composite adhesives and sealants used in assembly and packaging;
(c) Composites capable of directing heat flow through the presence of coefficient of thermal expansion gradients in single-crystalline samples. Such composites may form a basis for thermal circuitry, acting as thermal diodes;
(d) Optical devices including optical fibres, lasers, mirrors, lenses and interference devices; and
(e) Zero-insertion force sockets.

Several materials containing cyanide-bridged atoms were characterised structurally. Their thermal expansion properties were also monitored by structural investigation. It was noted that a large and diverse family of materials exhibiting a range of useful thermal expansion properties and containing the same basic structural motif of cyanide-bridged atoms could be synthesised. Notable differences between six types of characterised materials supported this understanding.

Materials with different degrees of interpenetration, topology, guest inclusion, charge, chemical composition and thermal expansion properties were also discovered. The common feature to each was the NTE component to the overall thermal expansion behaviour derived from the presence of M-CN-M′ linkages. Lattice effects were also noted to play a role in the anomalous thermal expansion properties of some of the compounds (eg those described in Examples 2 and 3 below).

The following non-limiting examples illustrate a diversity of anomalous expansion behaviours possible within cyanide-bridged materials constituted by or including the following compounds:

### Example 1

Unprecedented degrees of NTE were discovered in simple metal cyanides of the Zn(CN),structural family. The structure consisted of two interpenetrating diamond-type networks, with metal atoms acting as tetrahedral four-connectors, and cyanide ions as linear bridges.

Four salts were characterised structurally:

Zn(CN)₂ (A1);
ZnₓCd₁₋ₓ(CN)₂ (A2), where x˜0.80
ZnₓCd₁₋ₓ(CN)₂ (A3), where x˜0.64 and
Cd(CN)₂ (A4).

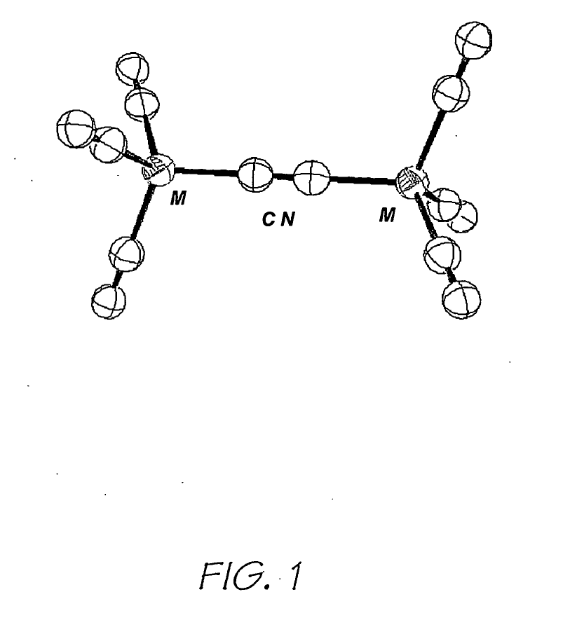

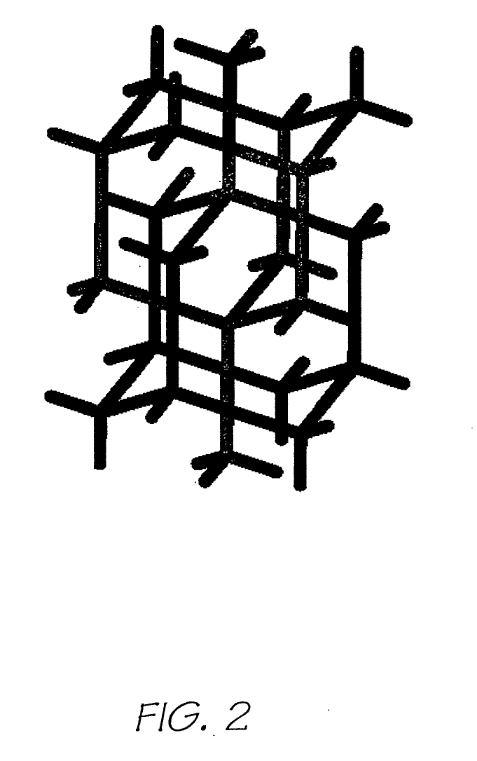

Two neutral diamond-type networks were observed to interpenetrate, each related by translation (see FIGS. 1 and 2). Further materials were synthesised by further variation of the metal units and, although these salts were not characterised, their similar crystal morphologies suggested the framework structure was retained.

Measured crystallographic details of A1 were: cubic, space group Pn-3m, unit cell a=5.9231(3) Å, V=207.81(3) Å³ (150 K); a=5.9142(3) Å, V=206.87(3) Å³ (225 K); a=5.9079(3)Å, V=206.21(3) Å³ (300 K); a=5.9011 (6), V=205.49 (6) Å³ (375 K).

Measured crystallographic details of A2 were: cubic, space group Pn-3m, unit cell a=6.00100(5) Å, V=216.10(5) Å³ (150 K); a=5.9927(4) Å, V=215.21 (3) Å³ (225 K); a=5.9843 (4)Å, V=214.31 (3) Å³ (300 K); a=5.9782 (4), V=213.65 (4) Å³ (375 K).

Measured crystallographic details of A3 were: cubic, space group Pn-3 m, unit cell a=6.055(3) Å(150 K), a=6.047 (3) Å(225 K); a=6.0380 (13) Å(300 K); a=6.0289(12) Å(375 K).

Measured crystallographic details of A4 were: cubic, space group Pn-3 m, unit cell a=6.325(2) Å, V=253.0(3) Å³ (150 K); a=6.3213(4) Å, V=252.29(4) Å³ (225 K); a=6.3022 (4) Å, V=250.31 (4) Å³ (375 K).

A4 was found to undergo reversible structural transitions at temperatures below 150 K. These transitions involved doubling and quadrupling of the unit cell parameter, with retention of the cubic symmetry.

FIG. 1 shows an ORTEP representation of the basic structural unit of the ZnₓCd₁₋ₓ(CN)₂ family, being part of the structure of compounds A1, A2, A3 and A4. Metal atoms are designated M and cyanide ions are designated CN. Each metal atom acts as a tetrahedral connector to four cyanide ions (ie. coordinates four cyanide ions in a tetrahedral arrangement). Each cyanide ion acts as a linear connector between two metal atoms. Each metal atom is coordinatively saturated in these compounds. Also, in each structure, the cyanide ion is disordered so that the C and N atoms are crystallographically indistinguishable.

FIG. 2 illustrates two interpenetrating diamond-type networks present in the ZnₓCd₁₋ₓ(CN)₂ structural family which are common to the structures of compounds A1, A2, A3 and A4. The two identical networks are shaded differently, are completely disjoint and are related to each other by translation and rotation. Each node in this illustration corresponds to a metal centre; the long rods correspond to M-CN-M′ linkages. There is no void volume or inclusion of guests in these compounds.

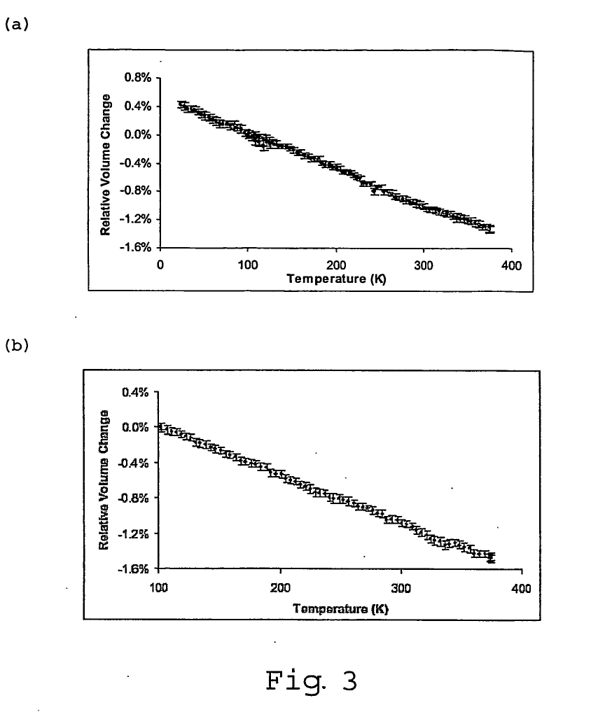

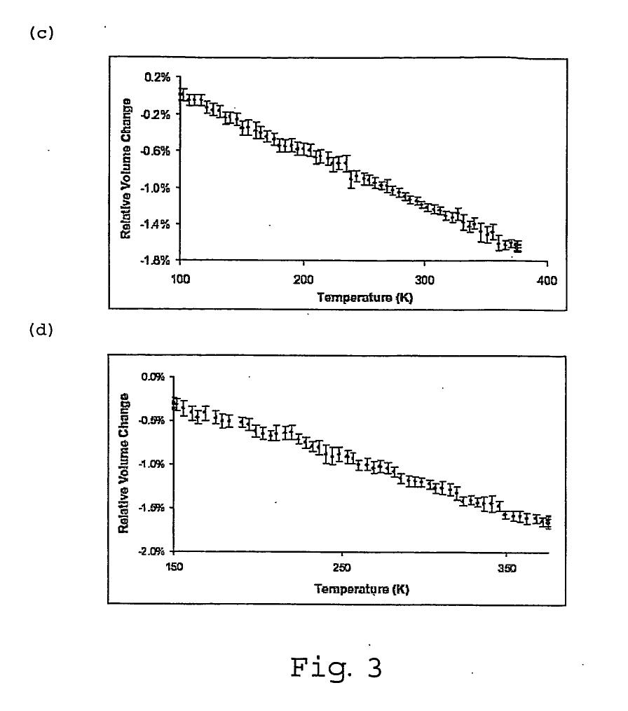

FIGS. 3(a), 3(b), 3(c) and 3(d) show the relative changes in unit cell volumes in each of the four members of the ZnₓCd₁₋ₓ(CN)₂ family. As each compound has cubic symmetry, the contractions indicated by these graphs is equal in all directions, or isotropic. The relative volume change in Cd(CN)₂ is the most pronounced example of isotropic NTE reported to date.

Referring now to FIG. 21, the variation of thermal displacement parameters of atoms in Zn(CN)₂ as determined by single crystal X-ray diffraction is depicted. The plot indicates that the transverse (normal) displacement parameters of the C and N atoms increase more rapidly with increasing temperature than do the isotropic displacement parameters of the Zn atom and the longitudinal (parallel) displacement parameters of the C and N atoms.

The composition of the structure common to the compounds A1-A4 was varied systematically and it was noted that with a potentially limitless number of solid solutions possible, that the expansion properties of these materials were able to be fine-tuned.

### Example 2

The lattice type, metal oxidation state and coordination preference of A1-A4 was varied and enabled the discovery of unprecedented uniaxial NTE in chiral mixed-metal cyanides. The structure of these materials consisted of six interpenetrated beta-quartz-type nets, imparting a hexagonal, rather than cubic symmetry.

Two salts were characterised structurally, namely:

Zn^{II}[Ag^{I}(CN)₂]₂.0.575{AgCN} (B1) and
Zn^{II}[Au^{I}(CN)₂]₂ (B2).

Six quartz networks were observed to interpenetrate, each related by translation or rotation. As for quartz, each network was chiral, and each of the six interpenetrated networks in B1 and B2 had the same handedness.

Crystallographic details of B1 were: hexagonal, space group P6₂22, unit cell a=9.416(6) Å, c=18.13(1) Å, V=1392(3) Å₃(107 K); a=9.451(3) Å, c=18.217(5) Å, V=1409.2(7) Å³ (200 K).

Crystallographic details of B2 were: hexagonal, space group P6₂22, unit cell a=8.435(1) Å, c=20.785(4) Å, V=1280.7(6) Å³ (150 K); a=8.440(3) Å, c=20.723(5) Å, V=1278.2(8) Å³ (200 K).

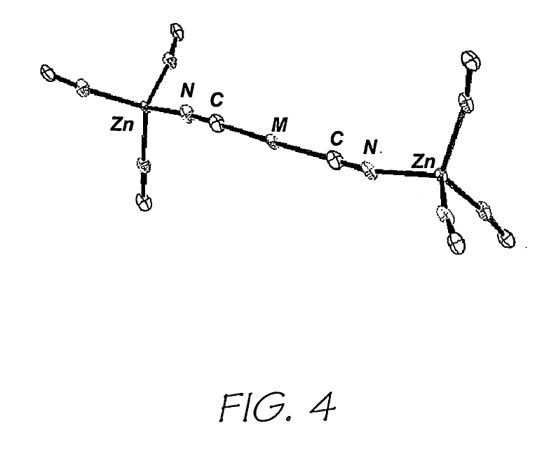

FIG. 4 is an ORTEP representation of the basic structural unit present in Zn^{II}[M^{I}(CN)₂]₂.x{guest}, (where M=Ag; Au and {guest} is as defined above), being part of the structures of B1 and B2. Each zinc atom (designated Zn) acts as a tetrahedral connector to four cyanide ions, being coordinated to the nitrogen atom of the four cyanide ions in a tetrahedral arrangement. Each gold or silver atom (designated M) acts as a slightly bent connector between two cyanide ions, the M atom being coordinated to the carbon atom of two cyanide ions in an approximately linear arrangement. Each cyanide ion (designated CN) acts as an approximately linear connector between a zinc atom and a gold or silver (M) atom.

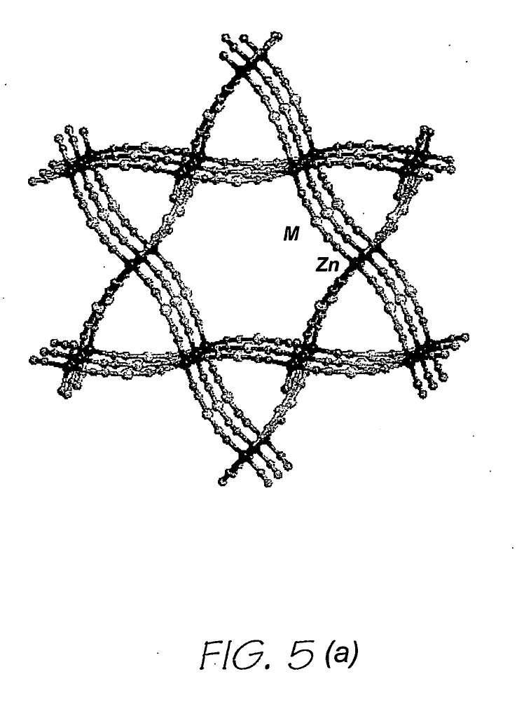

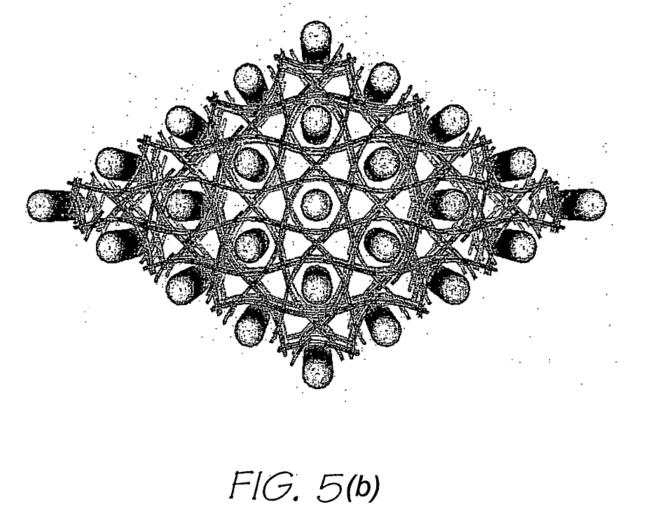

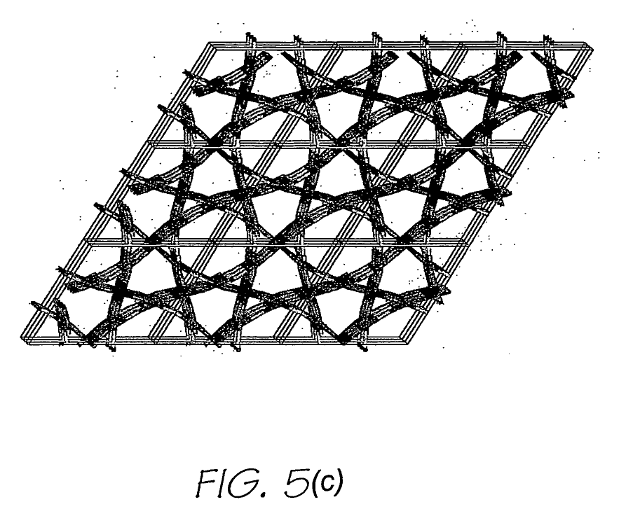

FIG. 5(a) illustrates one of the six interpenetrating beta-quartz-type networks that occurred in the structures of Zn^{II}[M^{I}(CN)₂]₂.x{guest}, (where M=Ag; Au and {guest} is as defined above), being part of the structures of B1 and B2. The M atoms are designated M and the zinc atoms are designated Zn. Each of the triangular channels in the representation is in fact a helix. Moreover, each helix has the same handedness, not only within each framework, but within the six frameworks that interpenetrate in the overall structure. Consequently, both materials grow as homochiral crystals and consequently rotate plane polarised light in only one direction.

FIGS. 5(b) and (c) illustrate the structures of B1 and B2, the structure of B1 containing 1-D chains of AgCN within the channels of the six interpenetrating networks, and the structure of B2 having empty channels.

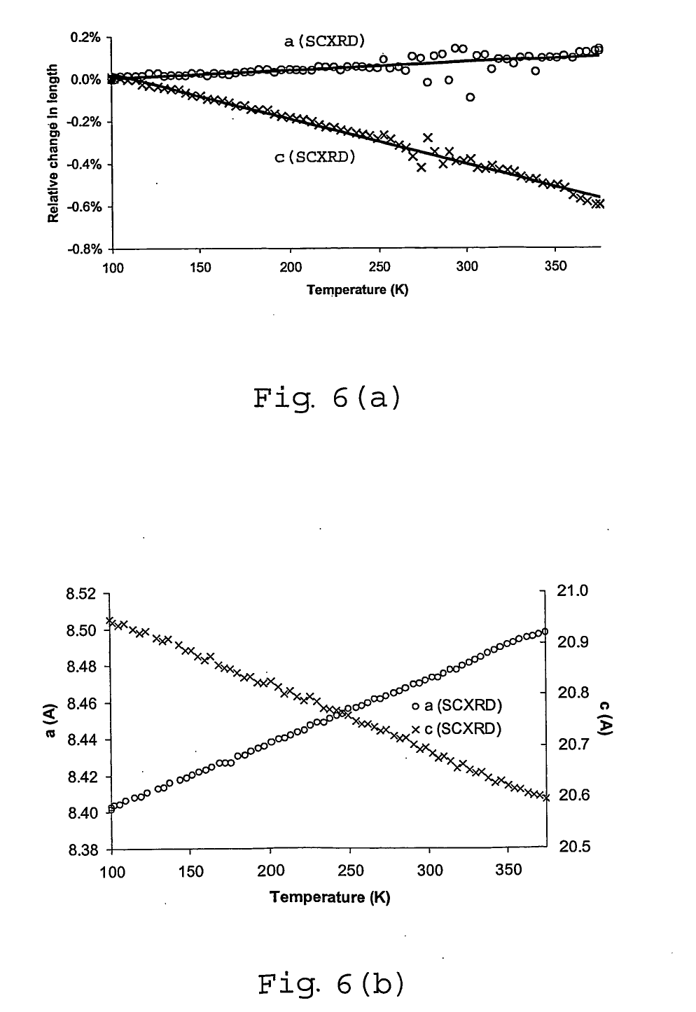

FIGS. 6(a) and 6(b) show the relative changes in unit cell parameters that occurred when each Zn^{II}[M^{I}(CN)₂]₂.{guest} network was heated. The variation of the metal M had significant effect on the thermal expansion properties of the material. Also noted was the large negative change in the relative magnitude of the c-axis in Zn^{II}[Au^{I}(CN)₂]₂. This was the most pronounced example of uniaxial NTE reported to date.

As with the materials A1-A4, compositional variation of the metal sites in B1 and B2 provided a potentially limitless number of solid solutions with different thermal expansion properties. Further, the incorporation of different guest species provided a potentially limitless number of materials with different thermal expansion properties. The topological difference between A1-A4 and B1 and B2 illustrated further the structural variability within simple cyanide-bridged materials.

### Example 3

Further variation of one of the metal components of B1 and B2 enabled the discovery of two new mixed-metal cyanides. These materials exhibited a different topology to that of B1 and B2, comprising three interpenetrating distorted cubic nets. Interstitial cations occupied vacancies between these nets. As observed for B2, these compounds exhibited uniaxial NTE.

Two salts were characterised structurally, namely:

KCd^{II}[Ag^{I}(CN)₂]₃ (C1) and
KCd^{II}[Au^{I}(CN)₂]₃ (C2).

Three distorted cubic nets interpenetrated, each related by translation or rotation. Vacancies between the nets were occupied by interstitial cations.

Crystallographic details of C1 were: hexagonal, space group P-3, unit cell a=6.855(3) Å, c=8.425(4) Å, V=342.9(3) Å³(107 K); a=6.900 Å, c=8.407 Å, V=346.6 Å³(200 K).

Crystallographic details of C2 were: hexagonal, space group P-3, unit cell a=6.777(3) Å, c=8.305(5) Å, V=330.3(3) Å³(107 K); a=6.8052 Å, c=8.2732 Å, V=331.81 Å³ (200 K).

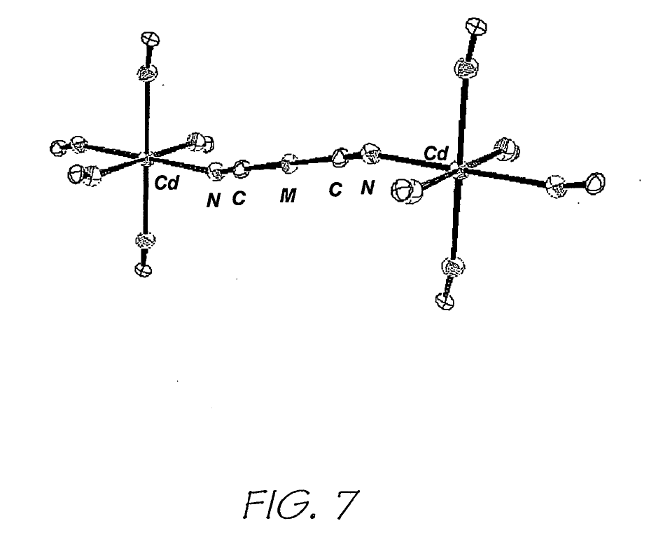

FIG. 7 shows an ORTEP representation of the basic structural unit in the KCd^{II}[M^{I}(CN)₂]₃ family (where M=Ag; Au), being part of the structure of compounds C1 and C2. Each cadmium atom (designated Cd) acts as an octahedral connector to six cyanide ions, being coordinated to the nitrogen atoms of six cyanide ions in an octahedral arrangement. Each silver or gold atom (designated M) acts as a linear connector between two cyanide ions, being coordinated by the carbon atoms of two cyanide ions. Each cyanide ion acts as a slightly-bent connector between a cadmium atom and a silver or gold atom. Potassium ions lie in interstitial cavities in which they are weakly coordinated by nitrogen atoms of surrounding cyanide ions (not shown in FIG. 7).

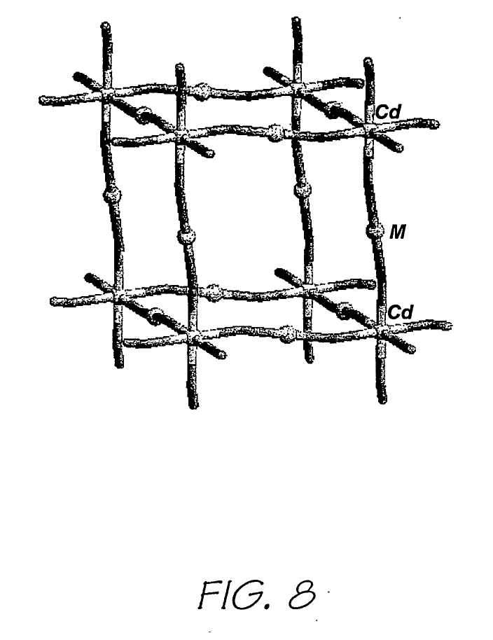

FIG. 8 illustrates one of the three interpenetrating distorted cubic networks that occur in the structure of the KCd^{II}[M^{I}(CN)₂]₃ family, being part of the structures of C1 and C2. The three nets interpenetrate, with interstitial cations occupying vacancies generated in the structure. The cadmium atoms (designated Cd) act as octahedral connectors to six M atoms through cyanide bridges. Each M atom (designated M) acts as a linear connector to two cadmium atoms through cyanide bridges.

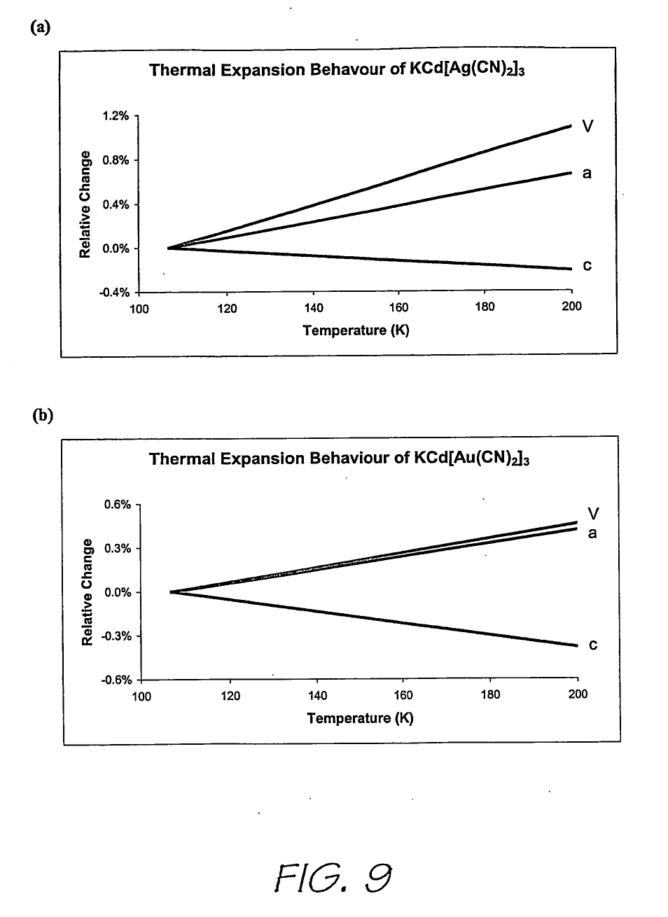

FIGS. 9(a) and 9(b) show the thermal expansion behaviour of the family KCd^{II}[M^{I}(CN)₂]₃ (where M=Ag; Au), illustrating the relative changes in unit cell parameters that occur in each network when heated. Of particular interest is the theme of NTE along the c-axis. As noticed with the Zn^{II}M^{I}₂(CN)₄ family, the extent of NTE is decreased upon replacement of gold atoms by silver atoms.

### Example 4

The A-type structure was varied to produce an anionic network which forced the inclusion of cations rather than a second interpenetrating diamond-type net into the adamantanoid cavities of the diamond-type framework. The presence of large unbound cations led to the discovery of PTE in this material. One salt was characterised structurally, namely:
[NMe₄][Cu^{I}Zn^{II}(CN)₄] (D)

Half of the adamantanoid cavities formed by the single anionic diamond-type network were occupied by tetramethylammonium cations.

Crystallographic details of D were: cubic, space group F-43 m, unit cell a=11.587(3) Å, V=1555.5(9) Å³ (107 K); a=11.6406(5) Å, V=1577.3(5) Å³ (200 K)

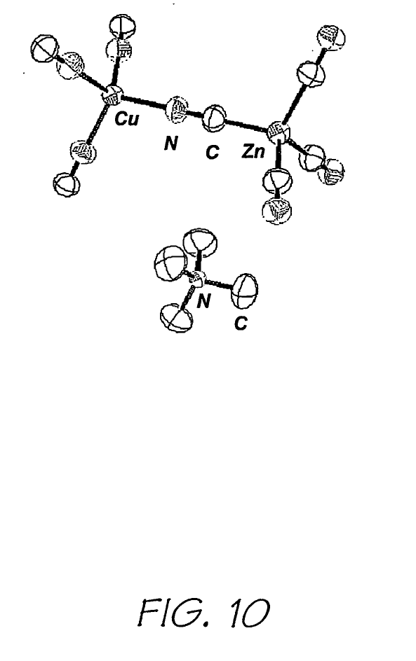

FIG. 10 is an ORTEP representation of the basic structural element of [NMe₄][Cu^{I}Zn^{II}(CN)₄], being part of the structure of D. The zinc and copper atoms (designated Zn and Cu respectively) each act as tetrahedral connectors to four cyanide ions. Each cyanide ion links a copper and a zinc atom in a linear arrangement, with the carbon atom being bound to a copper atom, and the nitrogen being bound to a zinc atom. Further, the cyanide ions are ordered so that each copper atom is bound to the carbon of each of four cyanide ions and each zinc atom binds the nitrogen of four cyanide ions. Overall charge balance is obtained by inclusion of the tetramethylammonium cation, which occupies every second adamantanoid cavity.

This structural unit may be compared to that of Zn(CN)₂ (see FIG. 1). The topologies are identical, except that the cation inclusion in this compound precludes the interpenetration of a second diamond-type net.

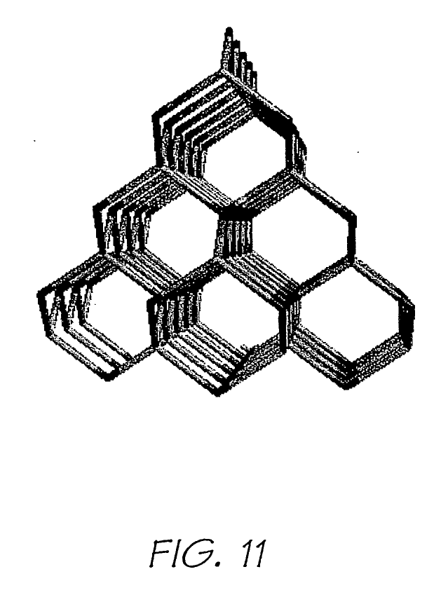

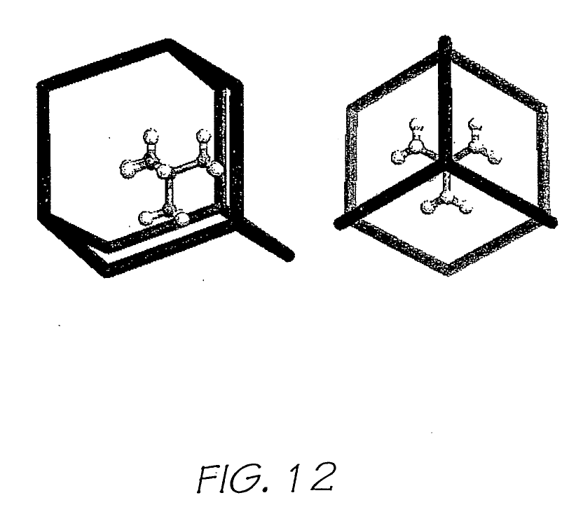

FIG. 11 is a representation of the diamond-type network present in [NMe₄][Cu^{I}Zn^{II}(CN)₄], part of the diamond-type network structure of D. The tetramethylammonium cations, which occupy some of the channel space, have been removed for clarity. Each node corresponds to a metal atom: Zn designating zinc atoms and Cu designating copper atoms. The rod-like connectors correspond to M-CN-M′ linkages.

FIG. 12 shows representations of the tetramethylammonium-filled adamantanoid cavities present in the structure of [NMe₄][Cu^{I}Zn^{II}(CN)₄], being one of the adamantanoid cavities present in the structure of D. Every second such cavity contains a tetramethylammonium cation, and the remainder are vacant. The cation is positioned so that each methyl group points towards one of the four hexagonal (or cyclohexane-like) ‘windows’ of the cavity.

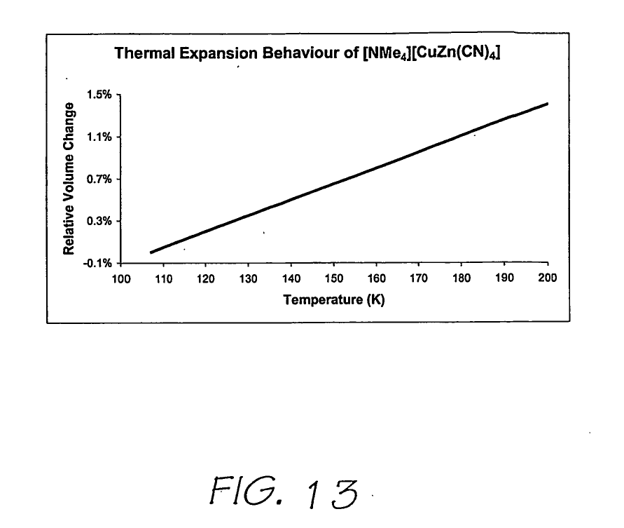

FIG. 13 is a graph of the thermal expansion behaviour of [NMe₄][Cu^{I}Zn^{II}(CN)₄], showing the relative volume change that occurs in compound D upon heating. The PTE of this material is in sharp contrast with the NTE exhibited by the parent structure of Zn(CN)₂.

### Example 5

Compounds A, B, C and D were further varied, leading to the discovery of new cyanide-bridged compounds in which some of the metals bound ligands other than cyanide, solvent was included and which contained non-linear M-CN-M′ linkages. The materials were observed to exhibit overall PTE and uniaxial ZTE. Two salts were characterised structurally, namely:
Cd^{II}Ni^{II}(CN)₄.xH₂O (E1) and
Cd^{II}Pt^{II}(CN)₄.xH₂O (E2).

The structure of E1 comprised stacked cyanide-bridged square grids with solvent water molecules joining subsequent layers. Ni and Cd atoms each acted as square-planar connectors, binding four cyanide ions. They occupied alternate positions in each layer, with each Cd atom coordinating two aquo ligands in an axial arrangement.

The structure of E2 comprised cyanide-bridged square grids with water molecules joining subsequent layers. Pt and Cd atoms each acted as square-planar connectors, binding four cyanide ions. They occupied alternate positions in each layer, with each Cd atom coordinating two bridging aquo ligands in a cis-arrangement.

Further materials were synthesised by further variation of the metal units, and although these salts were not characterised, their similar morphologies suggested that the framework structure was retained.

Crystallographic details of E1 were: orthorhombic, space group Cmcm, unit cell a=7.440(2) Å, b=12.216(3) Å, c=14.253(2) Å, V=1295.3(4) Å³ (107 K); a=7.464(4) Å, b=12.268(6) Å, c=14.250(5) Å, V=1304.8(9) Å³ (150 K).

Crystallographic details of E2 were: orthorhombic, space group 1222, unit cell a=9.869(3) Å, b=9.982(3) Å, c=10.709(2) Å, V=1054.9(6) Å³ (107 K); a=9.927(3) Å, b=10.039(3) Å, c=10.703(3) Å, V=1066.7(8) Å³ (200 K).

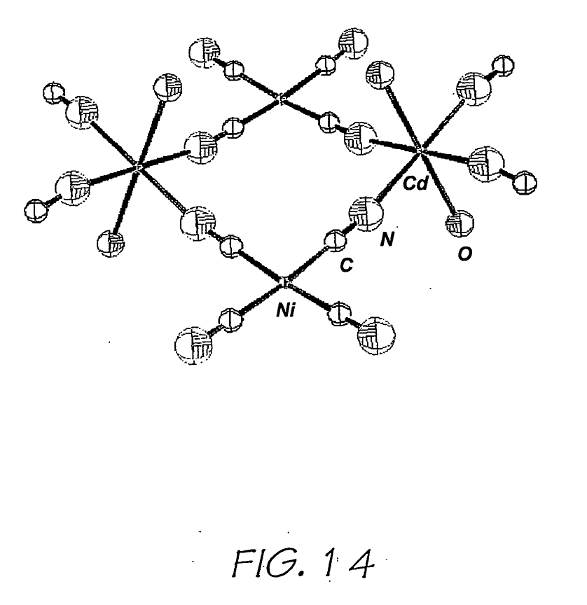

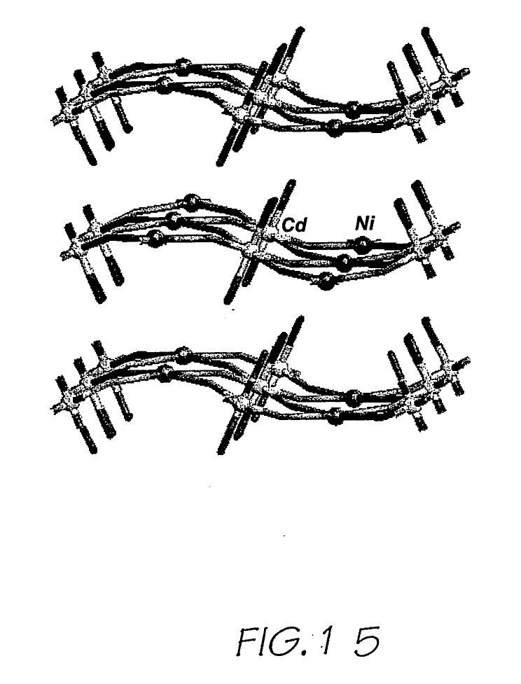

FIG. 14 shows an ORTEP representation of one of the ‘square grids’ present in the structure of Cd^{II}Ni^{II}(CN)₄.xH₂O, being part of the structure of E1. Each Nickel atom (designated Ni) binds four cyanide ions in a square planar arrangement, being coordinated by the carbon atoms of four cyanide ions in a square planar arrangement. Each cadmium atom (designated Cd) binds four cyanide ions in a square planar arrangement with two water molecules completing its octahedral coordination environment in the axial positions. Each cyanide ion bridges one Ni and one Cd atom in a non-linear fashion. The nitrogen atoms of four cyanide ions occupy four equatorial positions and two water molecules occupy the remaining two axial positions.

This connectivity resulted in two dimensional square grids, in which cadmium and nickel atoms alternated, bridged by cyanide ions. These grids then stacked on top of one another, with solvent water molecules (not illustrated in FIG. 14) occupying the space between layers (ie. occupying the interstitial cavities produced by the framework).

FIG. 15 shows a representation of the structure of Cd^{II}Ni^{II}(CN)₄, illustrating the stacked square grid arrangement in the structure of E1. In particular, FIG. 15 shows the stacking of cyanide-bridged square grids with alternating cadmium (designated Cd) and nickel (designated Ni) centres. Water molecules (omitted for clarity) occupy the void volume generated between subsequent layers. Each cyanide ion joins a cadmium centre and a nickel centre in a slightly-bent geometry, resulting in the wave-like topology of each sheet.

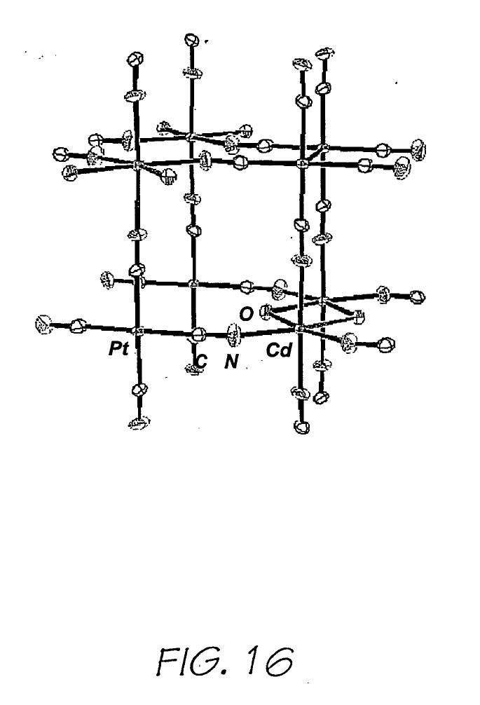

FIG. 16 shows an ORTEP representation of the basic structural unit present in Cd^{II}Pt^{II}(CN)₄, being part of the structure of E2. Each platinum atom (designated Pt) is coordinated in a square-planar arrangement by the carbon atom of four cyanide ions, and interacts weakly with a neighbouring platinum atom in a direction perpendicular to its coordination plane. Each cadmium atom (designated Cd) binds four cyanide ions in a see-saw arrangement with two bridging water molecules completing its octahedral coordination environment in adjacent positions. In particular, each cadmium centre has an octahedral coordination sphere, with four sites (in a see-saw arrangement) occupied by the nitrogen atom of four cyanide ions, and the remaining two sites occupied by water molecules. These water molecules also bind a nearby cadmium atom, linking adjacent sheets together. Water molecules (omitted from this diagram) occupy channels or interstitial cavities created in this structure. Each cyanide ion bridges one Pt and one Cd atom; some in a linear fashion, others with a bent geometry.

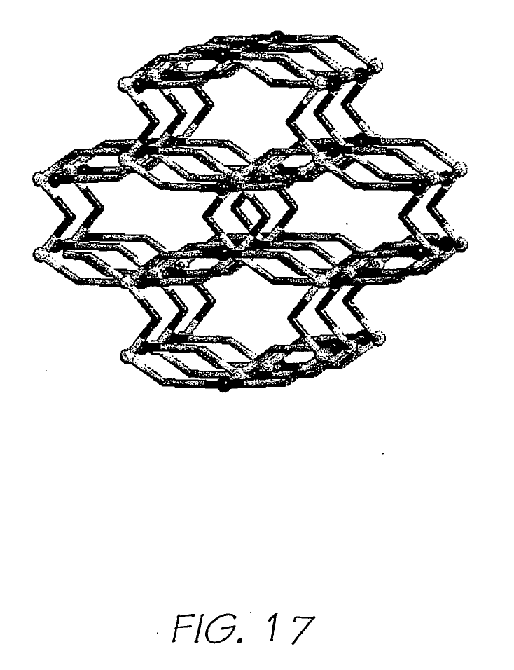

FIG. 17 shows a representation of the crystal structure of Cd^{II}Pt^{II}(CN)₄.xH₂O, illustrating the pseudo-cubic arrangement of the structure of E2. Square grids comprising alternating cyanide-linked cadmium (designated Cd) and platinum (designated Pt) centres are joined in three dimensions by bridging water molecules. Water molecules (omitted for clarity) occupy the void volume (channels) generated by this structure.

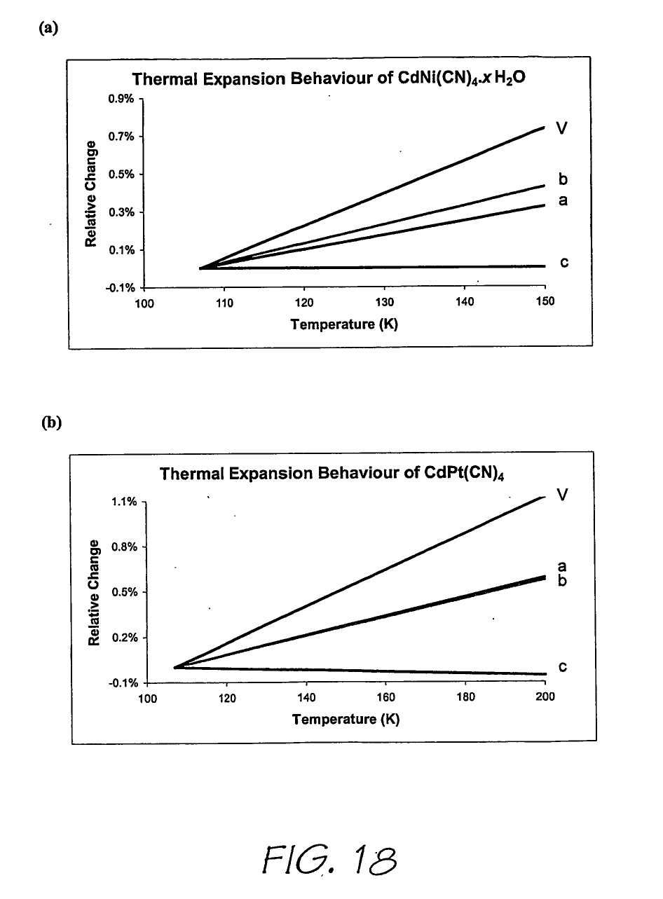

FIGS. 18(a) and 18(b) graph the thermal expansion behaviour of the Cd^{II}M^{II}(CN)₄.xH₂O family (where M=Ni; Pt), showing the relative changes in unit cell parameters that occur when each compound is heated. Of particular note is the uniaxial ZTE exhibited along the c-axis in both materials.

Examples 1 to 4 illustrate the versatility of thermal expansion properties possible in cyanide-bridged materials. The combination of the NTE effect caused by linear cyanide bridges with the PTE effect of solvent and interstitial ions together with variation of framework topology, degree of interpenetration and composition was observed to impart a subtle and powerful degree of control over the thermal expansion properties of these materials. Other subtle effects, such as cyanide order/disorder and defect inclusion were also observed to affect the thermal expansion properties of these materials.

The extent of NTE exhibited by compounds A1-A4, B2, C1 and C2 indicated that these materials would find diverse application in industry. However, it was the generality and tunability of the thermal expansion properties in these compounds that indicated that these compounds would become a highly important class of materials.

### Example 6

Further variation of the topology and metal components of A, B, C, D and E led to the discovery of new cyanide-bridged compounds. When formed, these compounds included water molecules within the cyanide framework. The thermal expansion behaviour of the materials was tunable by adjusting the quantity of water retained by the framework. Depending on their extent of hydration, the materials were observed to exhibit either isotropic NTE or isotropic PTE.

Four salts were characterised structurally:
Cd^{II}Pt^{IV}(CN)₆.2(H₂O) (F1);
Cd^{II}Pt^{IV}(CN)₆ (F2);
Zn^{II}Pt^{IV}(CN)₆.2(H₂O) (F3); and
Zn^{II}Pt^{IV}(CN)₆ (F4)

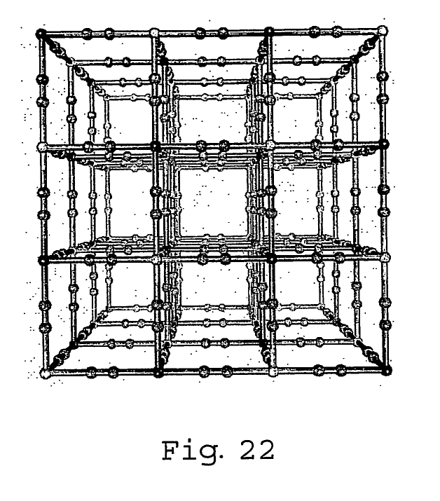

These materials consisted of a single neutral cubic (alpha-Po) network (see FIG. 22) in which guest molecules may or may not reside in the cubic cavities. Further materials were synthesised by further variation of the metal units and, although these salts were not characterised, their similar crystal morphologies suggested the framework structure was retained.

Measured crystallographic details of F1 were: cubic, space group Fm-3m, unit cell a=10.9530(2) Å, V=1314.00(14) Å³ (100 K); a=10.9486(5) Å, V=1312.4(5) Å³ (150 K); a=10.9423(2) Å, V=1310.34 Å³ (225 K).

Crystallographic details of F2 were: cubic, space group Fm-3m, unit cell a=10.9461(4) Å, V=1311.53(13) Å³ (100 K); a=10.9421(4) Å, V=1310.10(14) Å³ (150 K); a=10.9380(6) Å, V=1308.64(19) Å³ (225 K); a=10.9290(5) Å, V=1305.38(15) Å³ (300 K); a=10.9228(7) Å, V=1303.18(22) Å³ (375 K).

Crystallographic details of F3 were: cubic, space group Fm-3m, unit cell a=10.5467(4) Å, V=1173.2(4) Å³ (100 K); a=10.5590(2) Å, V=1177.25(17) Å³ (150 K); a=10.5565(5) Å, V=1176.4(5) Å³ (200 K); a=10.5533(6) Å, V=1175.3(6) Å³ (250 K).

Crystallographic details of F4 were: cubic, space group Fm-3m, unit cell a=10.5234(3) Å, V=1165.39(25) Å³ (100 K); a=10.5220(3) Å, V=1164.93(24) Å³ (150 K); a=10.5241 Å, V=1165.6(5) Å³ (225 K); a=10.5186(7) Å, V=1163.8 Å³ (300 K); a=10.5104(7) Å, V=1161.1(6) Å³ (375 K).

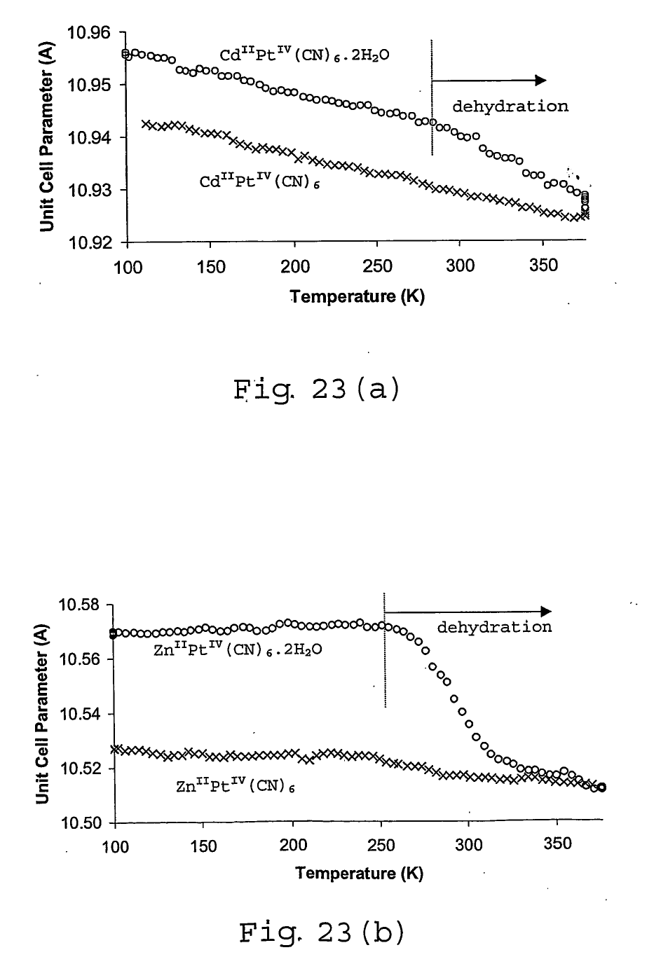

FIGS. 23(a) and 23(b) show the relative changes in the cubic unit cell parameter for each of the four members of the M^{II}Pt^{IV}(CN)₆.x(H₂O) (M=Cd, Zn; x=0, 2) family. With heating under nitrogen gas, F1 converts to F2 at temperatures above approximately 280 K, and F3 converts to F4 at temperatures above approximately 260 K.

FIGS. 25(a) and (b) show the variation of thermal displacement parameters of atoms in M^{II}Pt^{IV}(CN)₆ as determined by single crystal X-ray diffraction. In FIG. 25(a) M=Cd and in FIG. 25(b) M=Zn). The plots indicate that, compared to the longitudinal (parallel) thermal displacement parameters of the C and N atoms and the isotropic thermal displacement parameters of the Cd/Zn and Pt atoms, the transverse (normal) displacement parameter of the N atom increases the most rapidly with increasing temperature and that the transverse (normal) displacement parameter of the C atom also increases relatively rapidly in each material.

### Example 7

### Compound Synthesis and Characterisation

Synthesis

Single crystals of A1 and A2 were prepared by slow diffusion of solutions of zinc(II) acetate into stoichiometric (1:1) solutions of potassium tetracyanozincate(II) (A1) or potassium tetracyanocadmate(II) (A2). Single crystals of A4 were prepared by slow evaporation of a saturated solution of cadmium(II) cyanide prepared by mixing aqueous solutions containing stoichiometric amounts of cadmium(II) nitrate and potassium tetracyanocadmate(II).

Alternatively, single crystals of A1 were prepared by slow diffusion of aqueous solutions of potassium cyanide and zinc(II) acetate in stoichiometric quantities (2:1).

All three compounds were able to be prepared as bulk samples without the need for slow diffusion. Powder diffraction of samples prepared in this way illustrated the high degree of crystallinity of the products.

Many other salts were prepared in these ways, and although they were not structurally characterised, their morphology indicated that they would share the same structure as the compounds A1, A2, A3 and A4.

Diffusion techniques mentioned above included the use of:
(a) H-shaped cells, where the reactants diffused toward one another through the horizontal arm of the vessel;
(b) Test tubes, where an aqueous solution of one reagent was layered above an aqueous solution of the other reagent. Often a buffer region of pure solvent was introduced between the two solutions;
(c) U-shaped tubes, where the reagents diffused toward one another through a curved region beneath the initial position of the solutions.

Large colourless crystals were grown by each of these techniques over time periods ranging from days (test-tubes) and weeks (U-tubes) to months (H-cells).

Structural Characterisation

Single crystals of A1, A2, A3 and A4 were placed in Lindemann capillaries and transferred to a Bruker-AXS Smart 1000 CCD diffractometer equipped with Mo-K_{α} graphite monochromated radiation (lambda=0.71073 Å). The crystals were cooled either slowly or rapidly to 100 K. using an Oxford Instruments nitrogen cryostream or to 25 K. using an Oxford Instruments helium cryostream.

Data collections were performed at various temperatures over the range 25 to 375 K. Data collection, integration of frame data and conversion to intensities corrected for Lorentz, polarization and absorption effects were performed using the programs SMART, SAINT+ and SADABS. Structure solutions, refinement of the structures, structure analyses and production of crystallographic illustrations were carried out using the programs SHELXS-97, SHELXL-97, WebLab Viewer Pro and ORTEP.

Physical Characterisation

Diffuse reflectance infrared Fourier transform spectra of single-crystal samples of A1 and A2 were collected on a BIO-RAD FTS-40 spectrophotometer with Win-IR Windows based software. CsI was used as the matrix and background over a range of 100 to 4000 cm⁻¹. The spectra indicated the similarity in the symmetry of the two compounds. Both compounds absorbed significantly in only two regions, 450 cm⁻¹ and 2210 cm⁻¹, energies characteristic of metal-cyanide and cyanide vibrations.

A solid state ultraviolet/visible reflectance spectrum of a single-crystal sample of A1 was collected on a CARY 1E UV-Vis spectrophotometer equipped with custom designed Fourier transform analysis software. The spectrum indicated the optical transparency of the material.

### Example 8

### Synthesis and Characterisation

Synthesis

Single crystals of B1 were prepared by slow diffusion of solutions of silver(I) nitrate into stoichiometric (2:1) solutions of potassium tetracyanozincate(II). Alternatively, polycrystalline samples of B1 were prepared by diffusion of solutions of zinc(II) acetate into stoichiometric (1:2) solutions of potassium dicyanoargentate(I).

Large single crystals of B2 were prepared by slow diffusion of solutions of zinc(II) acetate into stoichiometric (1:2) solutions of potassium dicyanoaurate(I). The diffusion techniques included:
(a) Test tubes, where an aqueous solution of one reagent was layered above an aqueous solution of the other reagent. Often a buffer region of pure solvent was introduced between the two solutions;
(b) U-shaped tubes, where the reagents diffused toward one another through a curved region beneath the initial position of the solutions.

Large colourless hexagonal prisms were grown by each of these techniques over time periods ranging from days (test-tubes) to weeks (U-tubes). Each single crystal was observed to be homochiral and bulk samples consisted of equal quantities of enantiomorphic crystals.

Structural Characterisation

Single crystals of B1 and B2 were mounted on a mohair fibre using a thin film of perfluoropolyether oil and transferred to a Bruker-AXS Smart 1000 CCD diffractometer equipped with Mo-K_{α} graphite monochromated radiation (lambda=0.71073 Å). The crystals were cooled rapidly to 107 K using an Oxford Instruments nitrogen cryostream. Further data collections were performed at 150 K (B2) and 200 K (B1).

Data collection, integration of frame data and conversion to intensities corrected for Lorentz, polarization and absorption effects were performed using the programs SMART, SAINT+ and SADABS. Structure solutions, refinement of the structures, structure analyses and production of crystallographic illustrations were carried out using the programs SHELXS-97, SHELXL-97, WebLab Viewer Pro and ORTEP.

### Example 9

### Synthesis and Characterisation

Synthesis

Large single crystals of C1 and C2 were prepared by slow diffusion of solutions of cadmium(II) nitrate into stoichiometric (1:2) solutions of potassium dicyanoargentate(I) (C1) or potassium dicyanoaurate(I) (C2). Alternatively, single crystals of C1 were obtained by slow diffusion of solutions of silver(I) nitrate into stoichiometric (2:1) solutions of potassium tetracyanocadmate(II). Both compounds were also prepared as bulk samples without need for slow diffusion. Inspection indicated the high degree of crystallinity present in samples prepared in this way.

Diffusion techniques (described above) included the use of (a) test tubes, where an aqueous solution of one reagent was layered above an aqueous solution of the other reagent; often, a buffer region of pure solvent was introduced between the two solutions; (b) U-shaped tubes, where the reagents diffused toward one another through a curved region beneath the initial position of the solutions.

Large colourless triangular and hexagonal platelets were grown by each of these techniques over time periods ranging from days (test-tubes) to weeks (U-tubes).

Structural Characterisation

Single crystals of C1 and C2 were mounted on a mohair fibre using a thin film of perfluoropolyether oil and transferred to a Bruker-AXS Smart 1000 CCD diffractometer equipped with Mo-K_{α} graphite monochromated radiation (lambda=0.71073 Å). The crystals were cooled rapidly to 107 K using an Oxford Instruments nitrogen cryostream. Data were also collected at 200 K. Data collection, integration of frame data and conversion to intensities corrected for Lorentz, polarization and absorption effects were performed using the programs SMART, SAINT+ and SADABS.

Structure solutions, refinement of the structures, structure analyses and production of crystallographic illustrations were carried out using the programs SHELXS-97, SHELXL-97, WebLab Viewer Pro and ORTEP.

### Example 10

### Synthesis and Characterisation

Synthesis

Large single crystals of D were prepared by slow diffusion of solutions of tetrakisacetonitrilocopper(I) tetrafluoroborate, zinc(II) acetate and tetramethylammonium haxafluorophosphate into stoichiometric solutions of potassium cyanide. Diffusion techniques included (a) test tubes, where an aqueous solution of one reagent was layered above an aqueous solution of the other reagent; often a buffer region of pure solvent was introduced between the two solutions; (b) U-shaped tubes, where the reagents diffused toward one another through a curved region beneath the initial position of the solutions.

Colourless tetrahedra were grown by each of these techniques over time periods ranging from days (test-tubes) to weeks (U-tubes).

Structural Characterisation

A single crystal of D was mounted on a mohair fibre using a thin film of perfluoropolyether oil and transferred to a Bruker-AXS Smart 1000 CCD diffractometer equipped with Mo-K_{α} graphite monochromated radiation (lambda=0.71073 Å). The crystal was cooled rapidly to 107 K using an Oxford Instruments nitrogen cryostream. Data were collected at 107 K and again at 200 K. Data collection, integration of frame data and conversion to intensities corrected for Lorentz, polarization and absorption effects were performed using the programs SMART, SAINT+ and SADABS. Structure solutions, refinement of the structures, structure analyses and production of crystallographic illustrations were carried out using the programs SHELXS-97, SHELXL-97, WebLab Viewer Pro and ORTEP.

### Example 11

### Synthesis and Characterisation

Synthesis

Large single crystals of E1 and E2 were prepared by slow diffusion of solutions of cadmium(II) nitrate into stoichiometric (1:1) solutions of potassium tetracyanonickelate(II) (E1) or potassium tetracyanoplatinate (II) (E2). Such diffusion techniques included(a) test tubes, where an aqueous solution of one reagent was layered above an aqueous solution of the other reagent; often a buffer region of pure solvent was introduced between the two solutions;

(b) U-shaped tubes, where the reagents diffused toward one another through a curved region beneath the initial position of the solutions.

Colourless rods were grown by each of these techniques over time periods ranging from days (test-tubes) to weeks (U-tubes).

Structural Characterisation

Single crystals of E1 and E2 were mounted on a mohair fibre using a thin film of perfluoropolyether oil and transferred to a Bruker-AXS Smart 1000 CCD diffractometer equipped with Mo-K_{α} graphite monochromated radiation (lambda=0.71073 Å). The crystals were cooled rapidly to 107 K using an Oxford Instruments nitrogen cryostream. Data were collected at 107 K and again at 150 K (E1) or 200 K (E2).

Data collection, integration of frame data and conversion to intensities corrected for Lorentz, polarization and absorption effects were performed using the programs SMART, SAINT+ and SADABS. Structure solutions, refinement of the structures, structure analyses and production of crystallographic illustrations were carried out using the programs SHELXS-97, SHELXL-97, WebLab Viewer Pro and ORTEP.

### Example 12

### Synthesis and Characterisation

Synthesis

Large single crystals of F1 and F3 were prepared by slow evaporation of aqueous solutions containing stoichiometric quantities (1:1) of potassium hexacyanoplatinate(IV) and cadmium(II) nitrate (F1) or zinc(II) nitrate (F3). Transparent cubes of F1 and F3 were grown by this technique over time periods of the order of 24 hours.

Alternatively, larger single crystals of F1 were obtained by slow diffusion of solutions of potassium hexacyanoplatinate(IV) into stoichiometric (1:1) solutions of cadmium(II) nitrate. Such diffusion techniques included
(a) test tubes, where an aqueous solution of one reagent was layered above an aqueous solution of the other reagent. Often a buffer region of pure solvent was introduced between the two solutions;
(b) U-shaped tubes, where the reagents diffused toward one another through a curved region beneath the initial position of the solutions.

Transparent cubes of F1 were grown by each of these techniques over time periods ranging from days (test-tubes) to weeks (U-tubes).

Large single crystals of F2 and F4 were prepared by controlled heating of single crystals of F1 and F3, respectively to temperatures between 295 and 375 K.

Structural Characterisation

Single crystals of F1, F2, F3 and F4 were mounted on a mohair fibre using a thin film of perfluoropolyether oil and transferred to a Bruker-AXS Smart 1000 CCD diffractometer equipped with Mo-Kα graphite monochromated radiation (lambda=0.71073 Å). The crystals were cooled rapidly to 100 K using an Oxford Instruments nitrogen cryostream.

Data collections were performed at various temperatures over the range 100 to 375 K. Data collection, integration of frame data and conversion to intensities corrected for Lorentz, polarization and absorption effects were performed using the programs SMART, SAINT+ and SADABS. Structure solutions, refinement of the structures, structure analyses and production of crystallographic illustrations were carried out using the programs SHELXS-97, SHELXL-97, WebLab Viewer Pro and ORTEP.

Observations

The anomalous thermal expansion properties exhibited by the materials described above were observed to arise from the thermal population of transverse vibrational modes of cyanide ion bridges, thermal population of rigid unit modes (RUMs), lattice effects and from conventional causes of NTE in non-cyanide containing materials. In materials containing atoms bridged by cyanide ions, the most general cause of NTE was thermal population of the transverse vibrational modes.

The exact number and effect of these modes was also observed to depend on the geometry and symmetry of the cyanide bridge. However, at least one of the modes was observed to always contribute a negative component to the overall thermal expansion properties. Other aspects which contributed to the overall thermal expansion properties of the materials included their composition, topology and whether or not ions or guest molecules were included therein.

Judicious choice of the appropriate parameters allowed for preparation of materials with a range of desired thermal expansion behaviours.

Explanation of Anomalous Thermal Expansion Behaviour in Cyanide-Containing Materials

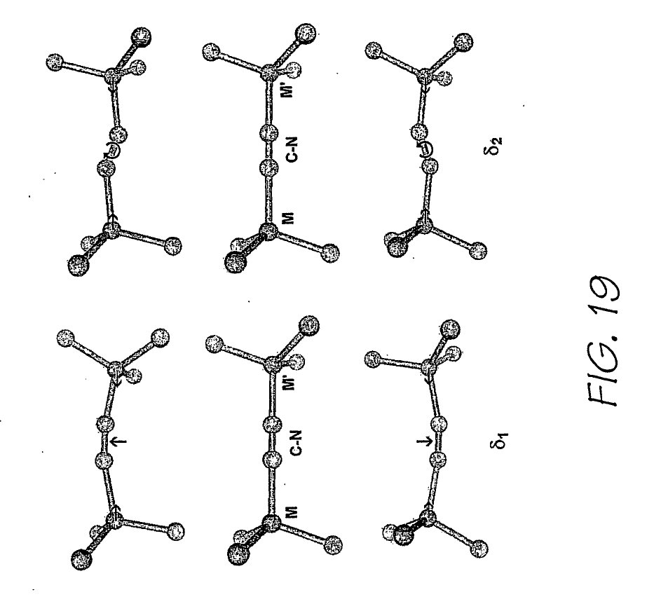

The δ₁ and δ₂ transverse vibrational modes are illustrated in FIG. 19 which depicts representations of the two transverse vibrational modes present in Zn(CN)₂ and similar systems with linear M-CN-M′ linkages. δ₁ involved the movement of the entire CN bridge away from the central M-M′ axis; δ₂ resembles a rotation of the CN bridge around an axis perpendicular to the central M-M′ axis. Both caused a decrease in the M-M′ distance.

The inventors noted that these vibrational modes both resulted in a net decrease of the M-M′ distance, which became more significant as the population of the modes was increased. The inventors discovered that these modes had sufficiently low energy that the negative contribution to the overall thermal expansion caused by population of these modes outweighed the positive contribution of the stretching modes, and that this was responsible for NTE in the ZnₓCd₁₋ₓ(CN)₂ family.

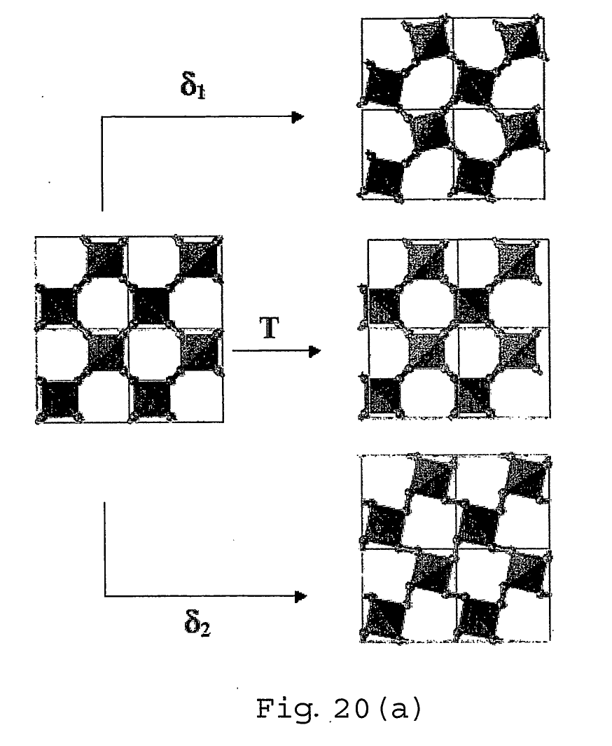

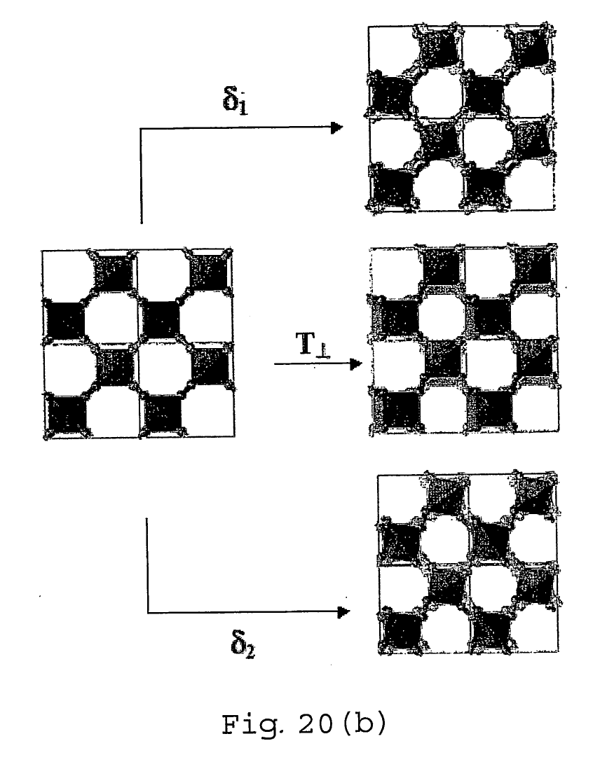

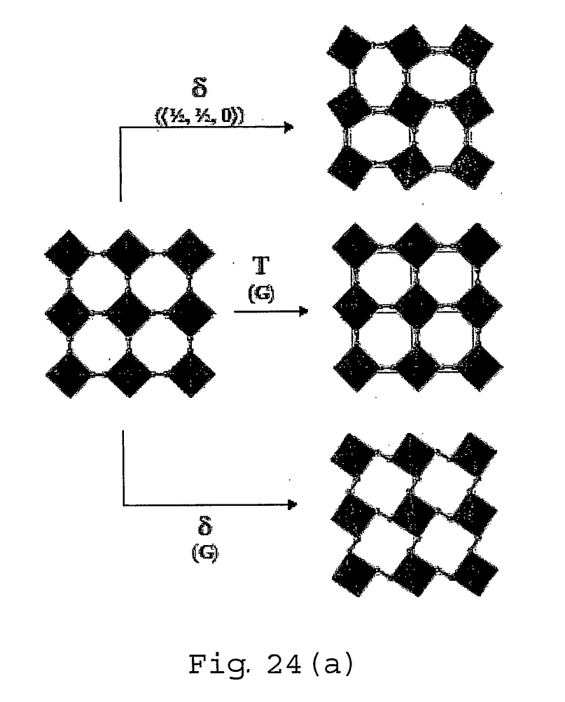

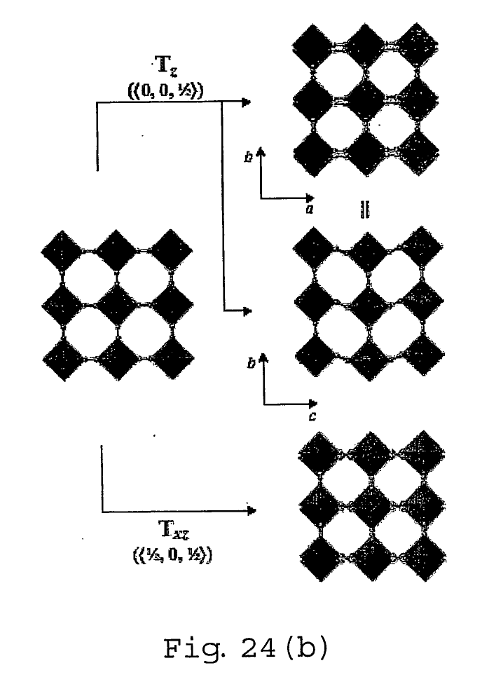

The inventors also noted that when a material contained a number of M-CN-M′ linkages joined in a polymeric fashion (such as in Zn(CN)₂), vibrational modes were often coupled into lattice vibrations (known as rigid unit modes or RUMs), being forms of phonon modes. The term ‘rigid unit’ was used because these modes caused little to no distortion in the rigid polyhedra (such as the [ZnCₓN₄₋ₓ] tetrahedra present in Zn(CN)₂). As such, they were typically of low energy, and hence were often more significantly populated than modes involving distortion or stretching of bond lengths (which could give rise to PTE). These RUMs were considered to be the manifestation of the above vibrational modes in a lattice, such that they also resulted in a net decrease in the M-M′ distance. Representations of a number of the RUMs present in the Zn(CN)₂ lattice are given in FIGS. 20(a) and 20(b); representations of a number of the RUMs present in the Zn^{II}Pt^{IV}(CN)₆ lattice are given in FIGS. 24(a) and 24(b).

In FIGS. 20(a) and 20(b), the zinc coordination spheres are illustrated as tetrahedra; the cyanide linkages as rods. In FIG. 20(a), the first RUM (top) was a lattice vibration in which adjacent tetrahedra rotated in opposite directions. This corresponded to every M-CN-M′ link undergoing the δ₁ vibrational mode. The second RUM (centre) was a lattice translation which did not involve any local vibrational motion of the M-CN-M′ links. The third RUM (bottom) was a lattice vibration in which all tetrahedra rotated in the same direction. This corresponded to every M-CN-M′ link undergoing the δ₂ vibrational mode.

In FIG. 20(b), each RUM corresponded to lattice vibration equivalent to the corresponding RUM in FIG. 20(a) except along the wave-vector <0,0,0.5>; this corresponded to M-CN-M′ links undergoing both δ₁ and δ₂ vibrational modes.

In FIGS. 24(a) and 24(b), the zinc and platinum coordination spheres are illustrated as equivalent octahedra; the cyanide linkages as rods. In FIG. 24(a), the first RUM (top) was a lattice vibration in which adjacent octahedra rotated in opposite directions; this corresponded to every M-CN-M′ link undergoing the δ₁ vibrational mode. The second RUM (centre) was a lattice translation which did not involve any local vibrational motion of the M-CN-M′ links. The third RUM (bottom) was a lattice vibration in which all octahedra rotated in the same direction. This corresponded to every M-CN-M′ link undergoing the δ₂ vibrational mode.

In FIG. 24(b), each RUM corresponds to the lattice translation RUM in 24(a) (centre) at the wave-vectors <0,0,0.5> (top and centre) and <0.5,0,0.5> (bottom). These corresponded to some M-CN-M′ links undergoing δ₁ and δ₂ vibrational modes.

The situation increased in complexity when the M-CN-M′ linkages deviated from the strictly linear ideal. Such systems often contained different vibrational modes, some of which contributed to positive- rather than negative-thermal expansion. However, a mode similar to the δ₂ mode mentioned above was found to necessarily exist, and to contribute a negative component to the overall thermal expansion behaviour of the material. Whether this and other NTE modes dominated over the PTE modes was sometimes difficult to predict and depended on the nature of each individual compound—its composition and structure.

The inventors also observed anomalous thermal expansion behaviour in some cyanide-containing materials (such as Zn[Au(CN)₂]₂) that appeared to arise not only from the above vibrational analysis, but also from lattice effects. Heating of these materials caused the geometry of the lattice itself to change, often resulting in uniaxial or anisotropic NTE. In addition to these effects, any of the causes of NTE in non-cyanide containing materials were also noted as potentially contributing an NTE component to appropriate CN-bridged compounds. Such phenomena were observed to include phase transitions, magnetic and electronic transitions and other (not necessarily CN-based) RUMs or phonon modes.

Any reference herein to a prior art document or use is not an admission that the document or use forms part of the common general knowledge of a skilled person in this field.

Whilst the invention has been described with reference to a number of preferred embodiments, it should be appreciated that the invention can be embodied in many other forms.

1. A method for controlling the thermal expansion behaviour of a material comprising the step of incorporating into the material a component including one or more diatomic bridges, the or each bridge extending between two atoms in the component, characterised in that the or each diatomic bridge has at least one vibrational mode that causes the two atoms on either side of the bridge to be moved together to a similar or greater extent than competing vibrational mode(s) that cause the two atoms on either side of the bridge to be moved apart.

2. A method as claimed in claim 1 wherein the component comprises a portion or the entirety of the material.

3. A method as claimed in claim 2 wherein the component comprises a portion of the material in an amount or manner that predetermines the material thermal expansion behaviour.

4. A method as claimed in claim 1 wherein the diatomic bridge has at least two vibrational modes δ1 and δ2 (as herein defined).

5. A method as claimed in claim 1 wherein the material comprises a plurality of diatomic bridges throughout an infinite molecular coordination network defining a lattice structure, such that changes in lattice geometry induce material negative thermal expansion behaviour.

6. A method as claimed in claim 1 wherein the diatomic bridge is linear.

7. A method as claimed in claim 1 wherein the diatomic bridge is defined by a linear cyanide —(CN)— bridge.

8. A method as claimed in claim 1 wherein the diatomic bridge is defined by a carbon monoxide —(CO)— bridge, a di-nitrogen —(NN)— bridge, a nitrogen monoxide —(NO)— bridge or a carbide —(CC)— bridge.

9. A method as claimed in claim 1 wherein the component comprises a plurality of diatomic bridges and, for at least some of the diatomic bridges, the two atoms that are linked by the diatomic, bridge are metals, semi-metals or non-metals.

10. A method as claimed in claim 9 wherein the two atoms on either side of the bridge are different atoms and thermal expansion is tuned by varying the relative ratios between two or more different atoms on either side of the diatomic bridge.

11. A method as claimed in claim 9 or 10 wherein the diatomic bridge is a cyanide ion coordinated to the metal or semi-metal atoms, and one or both metal or semi-metal atoms in turn coordinates one or more other cyanide ions, which in turn bridge to other atoms.

12. A method as claimed in claim 11 wherein each atom alternatively coordinates other ligands.

13. A method as claimed in claim 12 wherein the other ligands are uni- or multi-dentate, including water, alcohols, diols, thiols, oxalate, nitrate, nitrite, sulfate, phosphate, oxide, sulfide, thiocyanate, non-bridging cyanide, cyanate, nitrogen monoxide, carbon monoxide, dinitrogen.

14. A method as claimed in claim 13 wherein the material is an optionally desolvated salt.

15. A method as claimed in claim 13 or 44 wherein the component forms part of an assembly that is neutrally, positively or negatively charged.

16. A method as claimed in claim 15 wherein when the assembly carries a charge, counter-ions are incorporated within cavities within the assembly to provide neutrally charged materials.

17. A method as claimed in claim 16 wherein the counter-ions influence the thermal behaviour of the material, and counteract negative thermal expansion behaviour of the material.

18. A method as claimed in claims 16 or 17 wherein the material is porous.

19. A method as claimed in claim 18 wherein the counter-ions are included into pores of the material.

20. A method as claimed in claim 16 wherein the counter-ions are varied either by ion exchange or synthetic modification, to vary the thermal behaviour of the material.

21. A method as claimed in claim 13 wherein the material comprises guest molecules located in interstitial cavities within a lattice thereof.

22. A method as claimed in claim 21 wherein the guest molecules influence the thermal behaviour and optionally counteract negative thermal expansion behaviour of the material.

23. A method as claimed in claim 21 wherein the material is porous and the guest molecules are located in pores of the material.

24. A method as claimed in claim 21 wherein the guest molecules are varied either by sorption/desorption or synthetic modification, to vary the thermal behaviour of the material.

25. A method as claimed in claim 21 wherein the guest molecules comprise one of more of water, alcohols, organic solvents or gas molecules.

26. A method as claimed in claim 13 wherein the material has a topology based on a diamond-, wurzite-, quartz-, cubic-, (4,4)-, (6,3)-, (10,3)-, PtS-, NbO-, Ge₃N₄-, ThSiO₂- or PtOₓ-type net.

27. A method as claimed in claim 26 wherein the material comprises more than one interpenetrating net of the same or different topology.

28. A method as claimed in claim 1 wherein the material comprises zero-dimensional bridged moieties, such as CN bridged molecular squares.

29. A method for controlling the thermal expansion behaviour of a material comprising the step of incorporating into the material a component including one or more multi-atomic bridges, the or each bridge extending between two atoms in the material, characterised in that the or each multi-atomic bridge has at least one vibrational mode that causes the two atoms on either side of the bridge to be moved together to a similar or greater extent than competing vibrational mode(s) that cause the two atoms on either side of the bridge to be moved apart.

30. A method as claimed in claim 29 wherein the component comprises diatomic bridges as defined in claim 4, or polyatomic bridges such as cyanamide, dicyanamide, tricyanomethanide, thiocyanate, selenocyanate, cyanate, isothiocyanate, isoselenocyanate, isocyanate, azide, cyanogen or butadyinide.

31. (canceled)

32. (canceled)

33. (canceled)

34. (canceled)

35. A method for altering the thermal expansion behaviour of a material that comprises a component having a plurality of diatomic bridges, each bridge extending between two atoms in the component and having at least one vibrational mode that causes the two atoms on either side of the bridge to be moved together to a similar or greater extent than competing vibrational mode(s) that cause the two atoms on either side of the bridge to be moved apart, the method comprising the step of incorporating into the component two or more different atoms such that, for at least some of the diatomic bridges, the two atoms on either side of the bridge are different.

36. A method as claimed in claim 35 wherein the thermal expansion is tunable by varying the relative ratios between the two or more different atoms on either side of the diatomic bridge.

37. A method as claimed in claim 35 or 36 wherein the two atoms on either side of the bridge are different metals, semi-metals or non-metals, or combinations thereof.

38. (canceled)

39. A material having a thermal expansion behaviour controlled by the method of claim 1.

40. A material as claimed in claim 39 comprising one or more of:
(a) materials based on the Zn(CN)₂-type or 2×(6,4) cubic structure (doubly interpenetrating diamond nets), optionally including substitution of divalent metals for some or all of the Zn atoms, including Cd(II), Hg(II), Mn(II), Be(II), Mg(II), Pb(II) and Co(II), and optionally comprising substitution of mixtures of univalent, and optionally divalent and trivalent metal ions for Zn to give materials of the form:
{(M1₁^{II})ₓ₁(M1₂^{II})x2 . . . (M1ₙ^{II})ₓₙ}{(M2₁^{I})(M3₁^{III})}y1{(M2₂^{I})(M3₂^{III})}y2 . . . {(M2ₘ^{I})(M3ₘ^{III})}ym(CN)₂ where M1ᵢ includes Zn(II), Cd(II), Hg(II), Mn(II), Be(II), Mg(II), Pb(II) and Co(II); M2ⱼ includes Li(I) and Cu(I); M3ₖ includes Al(III), Ga(III) and In(III); n and m being any non-negative whole numbers with at least one greater than or equal to unity; and (x1+x2+ . . . +xn)+2×(y1+y2+ . . . +ym)=1; and i, j and k being any positive integer;
(b) materials of (a) but with a single diamond-type network rather than two interpenetrating networks, optionally with other ions or molecules incorporated into the structure, optionally with the inclusion of lower- or higher-valent metals into the network lattice;
(c) materials of (a) and (b) but with more than two interpenetrating diamond networks;
(d) materials based on Ga(CN)₃-type structure, optionally satisfying the general formula:
{(M1^{III})ₓ₁(M1₂^{III})ₓ₂ . . . (M1ₙ^{III})ₓₙ}{(M2₁^{III})(M3₁^{IV})}y1{(M2₂^{III})(M3₂^{IV})}_{y2} . . . {(M2ₘ^{II})(M3ₘ^{IV})}_{ym}(CN)₃ where M1 includes trivalent metal ions including Fe(III), Co(III), Cr(III), Ti(III), AI(III), Ir(III), Ga(III), In(III) and Sc(III); M2 includes divalent metal ions including Mg(II), Zn(II), Cd(II), Co(II), Fe(II), Ru(II), Mn(II) and Ni(II); M3 includes tetravalent metal ions such as Pd(IV) and Pt(IV); n and m being non-negative whole numbers with at least one greater than or equal to unity; and (x1+x2+ . . . +xn)+2×(y1+y2+ . . . +ym)=1;
(e) materials of (d) but with other ions or molecules being incorporated in the structure, including lower- or higher-valent metals in the network lattice;
(f) materials of (d) to (e) but with more than one interpenetrating cubic framework;
(g) other simple metal cyanides not explicitly belonging to (a) to (f) of the general form: (M1ⁿ¹⁺)ₓ₁(M2ⁿ²⁺)ₓ₂ . . . (Mk^{nk+})ₓₖ(CN)ᵢ(.{guest}) where M1, M2 . . . . Mk were metals with oxidation states n1+, n2+ . . . nk+ respectively; k and i were positive whole numbers; (x1×n1)+(x2×n2)+ . . . +(xk×nk)=i; and {guest}, when present, includes any solvent or molecular species such as water, alcohols, organic solvents or gas molecules, optionally including single or multiple interpenetrating regular nets including quartz, NbO, PtS, Ge₃N₄, (10,3), ThSiO₂, PtOₓ or wurtzite nets;
(h) materials of (g) but with other ions or molecules incorporated into the structure, including lower- or higher-valent metals in the network lattice;
(i) materials other than (h) comprising more than one type of network lattice;
(j) materials as in (a) to (i) but with metal and/or cyanide vacancies within the structure;
(k) materials other than (a) to (j) comprising cyanide-bridged atoms, including cyanide-bridged materials in which the coordination spheres of some or all metal atoms include one or more non-cyanide bridges, including water, alcohols, diols, thiols, oxalate, nitrate, nitrite, sulfate, phosphate, oxide, sulfide, thiocyanate, (non-bridging) cyanide, cyanate, nitrogen monoxide, carbon monoxide or dinitrogen, optionally comprising regular nets, and optionally including interstitial ions or guest molecules;
(l) materials of (k) that comprise finite cyanide-bridged moieties, optionally comprising cyanide-bridged polyhedra, polygons or finite chains, optionally comprising branches and components unrelated or unconnected to the cyanide-bridged moieties;
(m) materials of (a) to (l) where chemical composition is varied within the one crystal/crystallite by variation of crystallisation conditions, including concentrations and temperatures during crystallisation;
(n) materials of (a) to (l) where structure type, guest inclusion or ion inclusion is varied within the one crystal/crystallite; and
(o) amorphous materials or glasses based on any one of (a) to (n).

41. A material as claimed in claim 40 wherein:
material (a) comprises Zn(CN)₂, Zn_{0.8}Cd_{0.2}(CN)₂, Zn_{0.64}Cd_{0.36}(CN)₂, Cd(CN)₂, Mn(CN)₂, Zn_{0.5}Hg_{0.5}(CN)₂, Li_{0.5}Ga_{0.5}(CN)₂ and Cu_{0.5}Al_{0.5}(CN)₂;
material (b) comprises Cd(CN)₂.½CCl₄, [NMe₄]_{0.5}[Cu^{I}_{0.5}Zn^{II}_{0.5}(CN)₂], Cd(CN)₂.CMe₄, Cd(CN)₂.CMe₃Cl, Cd(CN)₂.CMe₂Cl₂, Cd(CN)₂.CMeCl₃, Cd(CN)₂.CCl₄, Cd_{0.5}Hg_{0.5}(CN)₂.CCl₄, Cd_{0.5}Zn_{0.5}(CN)₂.CCl₄;
material (d) comprises Ga^{III}(CN)₃, Co^{III}(CN)₃, Al^{III}(CN)₃, Cd^{II}_{0.5}Pt^{IV}_{0.5}(CN)₃ and Zn^{II}_{0.5}Pt^{IV}_{0.5}(CN)₃.;
material (e) comprises the Prussian blues compounds such as K[Fe^{II}Fe^{III}(CN)₆], and their analogues such as Cs₂[Li^{I}Fe^{III}(CN)₆], Cd^{II}_{0.5}Pt^{IV}_{0.5}(CN)₃.H₂O, Zn^{II}_{0.5}Pt^{IV}_{0.5}(CN)₃.H₂O, K[Fe^{II}Fe^{III}(CN)₆].xH₂O);
material (g) comprises Ag^{I}CN, Au^{I}CN, Zn^{II}Ag^{I}₂(CN)₄, Zn^{II}Au^{I}₂(CN)₄;
material (h) comprises KCd^{II}[Ag^{I}(CN)₂]₃ and KCd^{II}[Au^{I}(CN)₂]₃;
material (i) comprises Zn^{II}Ag^{I}₂(CN)₄.0.575Ag^{I}CN;
material (j) comprises Mn^{II}Co^{III}_{0.33}Cr^{II}_{0.33}(CN)₄, Cd^{II}Fe^{III}_{0.33}Co^{III}_{0.33}(CN)₄, Cd^{II}Co^{II}_{0.33}Ir^{II}_{0.33}(CN)₄, Pd^{II}Cr^{III}_{0.33}Ir^{II}_{0.33}(CN)₄ and Cu^{II}Co^{III}_{0.66}(CN)₄.;
material (k) comprises Ni^{II}(CN)₂.xH₂O, Fe₄[Re₆Se₈(CN)₆]₃.36H₂O, Cd^{II}Ni^{II}(CN)₄.xH₂O and Cd^{II}Pt^{II}(CN)₄.xH₂O; and
material (m) comprises ZnₓCd₁₋ₓ((CN)₂.

42. A material that comprises a component having a plurality of diatomic bridges, each bridge extending between two atoms in the component and having at least one vibrational mode that causes the two atoms on either side of the bridge to be moved together to a similar or greater extent than competing vibrational mode(s) that cause the two atoms on either side of the bridge to be moved apart, wherein, for at least some of the diatomic bridges, the two atoms on either side of the bridge are different.

43. A material as claimed in claim 42 wherein the two atoms on either side of the bridge are different metals, semi-metals or non-metals, or combinations thereof.

44. A composite incorporating a material as claimed in claim 40 or 41.

45. A composite as claimed in claim 44 comprising two or more different materials, at least one of which is produced by the method of claim 1 or 29.

46. A composite as claimed in claim 45 further comprising a binding agent for the two or more different materials.

47. A composite as claimed in claim 45 including a material produced by the method of claim 1 or 29 together with an unrelated material (as herein defined).

48. A composite as claimed in claim 47 further comprising a binding agent for the material and unrelated material.

49. A device formed from or comprising material having controllable thermal expansion behaviour, the material being produced by a method as claimed in claim 1, or being as claimed in claim 40 or 41.

50. A device as claimed in claim 49 that is: an optical fibre; a laser; an optical, electronics or thermal electronics component; a substrate or support for an optical component, electronics device or thermal electronics device; a thermal transfer device; a zero insertion force socket; a component for a superconductor, high precision instrument or frequency resonator; an optical device displaying birefringence or that is optically transparent; an interference device;
or a device that displays: piezoelectric properties; optical activity; or nonlinear optical properties.

51. A method for directing the thermal expansion behaviour of a material comprising the step of incorporating into the material a component including one or more diatomic bridges, the or each bridge extending between two atoms in the component, with the or each diatomic bridge having at least one vibrational mode that causes the two atoms on either side of the bridge to be moved together to a similar or greater extent than competing vibrational mode(s) that cause the two atoms on either side of the bridge to be moved apart, characterised in that the component comprises an anisotropic single crystal that, by virtue of its alignment in the material, directs thermal expansion.

52. A material having directed thermal expansion behaviour, the material being produced by the method of claim 51.

53. A method as claimed in claim 51 wherein the component comprises a portion or the entirety of the material.

54. A material as claimed in claim 52 wherein the component comprises a portion or the entirety of the material.
